(19) United States
(12) Patent Application Publication
(10) Pub. No.: US 2026/0328968 A1
(43) Pub. Date: Oct. 22, 2026

(54) SEMITRANSPARENT ANTIREFLECTIVE ASSEMBLIES FOR DEADFRONT DISPLAY APPLICATIONS

(71) Applicant: CORNING INCORPORATED, CORNING, NY (US)

(72) Inventors: Robert Alan Bellman, Ithaca, NY (US); Haixing Chen, Shanghai (CN); Guiming Gao, Hefei (CN); Xu Ouyang, Painted Post, NY (US); Yawei Sun, Elmira, NY (US)

(21) Appl. No.: 19/108,827

(22) PCT Filed: Aug. 24, 2023
(86) PCT No.: PCT/US2023/031010

§ 371 Date: Mar. 5, 2025

(30) Foreign Application Priority Data
Sep. 6, 2022 (CN) 202211086838.8

(51) Int. Cl. G02B 1/116; C03C 17/22; C03C 17/34; C03C 17/36; G02B 5/00

(52) U.S. Cl. CPC G02B 1/116; C03C 17/22; C03C 17/3417; C03C 17/3435; C03C 17/3441; C03C 17/3642; C03C 17/3649; C03C 17/3657; G02B 5/003; C03C 2217/213; C03C 2217/218; C03C 2217/26; C03C 2217/261; C03C 2217/27; C03C 2217/281; C03C 2217/734; C03C 2218/153; C03C 2218/154

(57) ABSTRACT

A cover article for a display panel that includes: a substrate comprising a thickness from 50 μm to 5000 μm, an outer primary surface and an inner primary surface, wherein the substrate comprises a glass, glass-ceramic or ceramic material; an inner layered film disposed on the outer primary surface of the substrate; and an outer layered film disposed on the inner layered film. One or both of the inner layered film and the outer layered film comprises one or more absorber layers. The outer layered film comprises a plurality of alternating high refractive index and low refractive index layers. Each absorber layer exhibits a sheet resistance of at least 10⁵ Ohms/sq. Further, the article exhibits a deadfront color shift (ΔE) of less than 4.0 for incident, measuring angles from 0° to 90°.

### CROSS-REFERENCE TO RELATED APPLICATIONS

This application claims the benefit of priority under 35 U.S.C. § 119 of Chinese Patent Application Serial No. 202211086838.8 filed on Sep. 6, 2022, the content of which is relied upon and incorporated herein by reference in its entirety.

### FIELD OF THE DISCLOSURE

This disclosure relates to a cover article for deadfront displays, and more particularly to vehicle interior systems including a deadfront cover article with semitransparent and antireflective properties.

### BACKGROUND

In various applications involving displays, it is desirable to have a display surface or functional surface having a deadfront appearance. In general, a deadfront appearance is a way of hiding a display or functional surface such that there is a seamless transition between a display and a non-display area, or between the deadfronted area of an article and non-deadfronted area or other surface. For example, in a typical display having a glass or plastic cover surface, it is possible to see the edge of the display (or the transition from display area to non-display area) even when the display is turned off. However, it is often desirable from an aesthetic or design standpoint to have a deadfronted appearance such that, when the display is off, the display and non-display areas present as indistinguishable from each other and the cover surface presents a unified appearance.

One application where a deadfront appearance is desirable is in automotive interiors, including in-vehicle displays or capacitive touch interfaces, as well as other applications in consumer mobile or home electronics, including mobile devices and home appliances. However, it is difficult to achieve both a good deadfront appearance and, when a display is on, a high-quality display.

Conventional approaches to achieving a deadfront appearance include depositing a non-conductive black ink on one primary surface of a transparent substrate and an antireflective (AR) coating on the opposing primary surface of the substrate. Screen or inkjet printing processes and apparatus can be used for the black ink layer and vacuum deposition processes and apparatus can be used for the AR coating. Ultimately, the conventional approach is expensive because it requires at least two separate deposition processes with differing deposition apparatus.

Accordingly, there is a need for cover articles for deadfront displays, and more particularly for capacitive touchscreen applications such as vehicle interior systems, including a deadfront cover article with semitransparent and antireflective properties that can be made with processes and apparatus resulting in low manufacturing cost.

### SUMMARY

According to an aspect of the disclosure, a cover article for a display panel is provided that includes: a substrate comprising a thickness from 50 μm to 5000 μm, an outer primary surface and an inner primary surface, wherein the outer and inner primary surfaces are opposite of one another and the substrate comprises a glass, glass-ceramic or ceramic material; an inner layered film disposed on the outer primary surface of the substrate; and an outer layered film disposed on the inner layered film. One or both of the inner layered film and the outer layered film comprises one more absorber layers. The outer layered film comprises a plurality of alternating high refractive index and low refractive index layers. Each of the high refractive index layers has a refractive index greater than a refractive index of each of the low refractive index layers. Each absorber layer exhibits a sheet resistance of at least 10⁵ Ohms/sq. Further, the article exhibits a deadfront color shift (ΔE) of less than 4.0 for incident, measuring angles from 0° to 90°, as measured relative to a control article comprising the glass, glass-ceramic or ceramic material of the substrate and a standard black matrix disposed on the glass, glass-ceramic or ceramic material.

According to another aspect of the disclosure, a cover article for a display panel is provided that includes: a substrate comprising a thickness from 50 μm to 5000 μm, an outer primary surface and an inner primary surface, wherein the outer and inner primary surfaces are opposite of one another and the substrate comprises a glass, glass-ceramic or ceramic material; an inner layered film disposed on the outer primary surface of the substrate; and an outer layered film disposed on the inner layered film. The inner layered film comprises a plurality of low refractive index and absorber layers. The outer layered film comprises a plurality of alternating high refractive index and low refractive index layers. Each of the high refractive index layers has a refractive index greater than a refractive index of each of the low refractive index layers. In addition, each absorber layer comprises a metal or a metal alloy. Each absorber layer exhibits a sheet resistance of at least 10⁵ Ohms/sq and an extinction coefficient of greater than 0.05 in the visible spectrum from 400 nm to 700 nm.

According to a further aspect of the disclosure, a cover article for a display panel is provided that includes: a substrate comprising a thickness from 50 μm to 5000 μm, an outer primary surface and an inner primary surface, wherein the outer and inner primary surfaces are opposite of one another and the substrate comprises a glass, glass-ceramic or ceramic material; an inner layered film disposed on the outer primary surface of the substrate; and an outer layered film disposed on the inner layered film. One or both of the inner layered film and the outer layered film comprises one or absorber layers. The outer layered film comprises a plurality of alternating high refractive index and low refractive index layers. Each of the high refractive index layers has a refractive index greater than a refractive index of each of the low refractive index layers. In addition, each absorber layer comprises a diamond-like carbon (DLC) material. Each absorber layer exhibits a sheet resistance of at least 10⁵ Ohms/sq and an extinction coefficient from about 0.05 to about 0.4 in the visible spectrum from 400 nm to 700 nm.

According to another aspect of the disclosure, a cover article for a display panel is provided that includes: a substrate comprising a thickness from 50 μm to 5000 μm, an outer primary surface and an inner primary surface, wherein the outer and inner primary surfaces are opposite of one another and the substrate comprises a glass, glass-ceramic or ceramic material; an inner layered film disposed on the outer primary surface of the substrate; and an outer layered film disposed on the inner layered film. The inner layered film comprises a plurality of low refractive index and one or more absorber layers. The outer layered film comprises a plurality of alternating high refractive index and low refractive index layers. Each of the high refractive index layers has a refractive index greater than a refractive index of each of the low refractive index layers. In addition, each absorber layer is a silicon-metal alloy comprising Si—Al, Si—Sn, Si—Zn or a combination thereof. Each absorber layer exhibits a sheet resistance of at least 10⁵ Ohms/sq and an extinction coefficient of greater than 1.0 in the visible spectrum from 400 nm to 700 nm.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1A is a cross-sectional side view of a cover article, according to one or more embodiments described herein;

FIG. 1B is a cross-sectional side view of a cover article, according to one or more embodiments described herein;

FIG. 1C is a cross-sectional side view of a cover article, according to one or more embodiments described herein;

FIG. 1D is a cross-sectional side view of a cover article, according to one or more embodiments described herein;

FIG. 2A is a plot of the inverse of sheet resistance vs. film thickness for chromium films of various thicknesses deposited at 23° C. and 325° C., according to embodiments of the disclosure;

FIG. 2B is a plot of absorptance vs. wavelength for a glass substrate and chromium films of various thicknesses deposited on the glass substrate at 23° C., according to embodiments of the disclosure;

FIGS. 2C and 2D are scanning electron microscopy (SEM) images of a chromium film having a thickness of 1.8 nm deposited at 23° C. and a thickness of 1.3 nm deposited at 325° C., respectively, according to embodiments of the disclosure;

FIG. 3A is a plot of the inverse of sheet resistance vs. film thickness for nickel films of various thicknesses deposited at 23° C. and 325° C., according to embodiments of the disclosure;

FIG. 3B is a plot of absorptance vs. wavelength for nickel films of various thicknesses deposited on a glass substrate at 23° C., according to embodiments of the disclosure;

FIGS. 4A-4C are plots of transmittance vs. wavelength for one, two and three layers of chromium at three thickness levels, respectively, with thin layers of silica deposited between each chromium layer, according to embodiments of the disclosure;

FIG. 5 is a plot of reflectance, transmittance and absorptance v. wavelength for an exemplary cover article of the disclosure employing chromium absorber layers;

FIG. 6 is a plot of reflectance, transmittance and absorptance v. wavelength for an exemplary cover article of the disclosure employing nickel absorber layers;

FIG. 7 is a plot of refractive index and extinction coefficient (n, k) of a diamond-like carbon (DLC) layer, as deposited with a plasma-enhanced chemical vapor deposition process, according to an embodiment of the disclosure;

FIG. 8A is a plot of reflectance, transmittance and absorption v. wavelength for an exemplary cover article of the disclosure employing a single DLC layer;

FIG. 8B is a plot of reflectance, transmittance and absorption v. wavelength for an exemplary cover article of the disclosure employing five DLC layers;

FIG. 8C is a plot of reflectance, transmittance and absorption v. wavelength for an exemplary cover article of the disclosure employing three DLC layers;

FIG. 9A is a plot of reflectance and transmittance v. wavelength for exemplary cover articles of the disclosure employing a single DLC layer with varying thickness levels, respectively;

FIG. 9B is a plot of first-surface reflected color with a D65 illuminant at a normal incident measuring angle for the exemplary cover articles of FIG. 9A and comparative cover articles with black matrix material;

FIG. 10A is an optical image of cover articles with a half-portion having the structures of FIG. 9A and the other half-portion with the black matrix material of FIG. 9B, according to embodiments of the disclosure;

FIG. 10B is a bar graph of deadfront color shift (ΔE) of the cover articles of FIGS. 9A and 9B, as measured at incident angles of 0°, 450 and 90°, according to embodiments of the disclosure;

FIG. 11A is a plot of the ratio of extinction coefficient (k) at 400 nm to 550 nm and 780 nm to 440 nm for Si—Al films as a function of Si volume fraction, according to embodiments of the disclosure;

FIGS. 11B-11D are respective plots of reflectance, transmittance and absorptance vs. wavelength for three Si—Al film compositions at two film thicknesses, according to embodiments of the disclosure;

FIG. 12 is a plot of the ratio of extinction coefficient (k) at 400 nm to 550 nm and 780 nm to 440 nm for Si—Zn films as a function of Si volume fraction, according to embodiments of the disclosure;

FIG. 13 is a plot of the ratio of extinction coefficient (k) at 400 nm to 550 nm and 780 nm to 440 nm for Si—Sn films as a function of Si volume fraction, according to embodiments of the disclosure;

FIG. 14 is a plot of the ratio of extinction coefficient (k) at 400 nm to 550 nm and 780 nm to 440 nm for comparative Si—Cu films as a function of Si volume fraction;

FIG. 15 is a plot of the ratio of extinction coefficient (k) at 400 nm to 550 nm and 780 nm to 440 nm for comparative Si—Cr films as a function of Si volume fraction;

FIG. 16A is a is a plot of simulated reflectance, transmittance and absorptance v. wavelength for an exemplary cover article of the disclosure employing a Si—Al absorber layers; and

FIG. 16B is a simulated color plot of x and y coordinates in the 1931 CIE scale for the cover article of FIG. 16A, according to an embodiment of the disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Further, when one or both endpoints of a range, or any particular value, is expressed using the term “about”, each such endpoint or value modified by “about” can be varied within +5% of the stated endpoint or value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example “up,” “down,” “right,” “left,” “front,” “back,” “top,” “bottom”—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

As used herein, the term “dispose” includes coating, depositing, and/or forming a material onto a surface using any known or to be developed method in the art. The disposed material may constitute a layer, as defined herein. As used herein, the phrase “disposed on” includes forming a material onto a surface such that the material is in direct contact with the surface and embodiments where the material is formed on a surface with one or more intervening material(s) disposed between the material and the surface. The intervening material(s) may constitute a layer, as defined herein.

As used herein, the terms “low RI layer” and “high RI layer” refer to the relative values of the refractive index (“RI”) of layers of an optical film structure of a cover article according to the disclosure (i.e., low RI layer<high RI layer). Hence, low RI layers have refractive index values that are less than the refractive index values of high RI layers. Further, as used herein, “low RI layer” and “low index layer” are interchangeable with the same meaning. Likewise, “high RI layer” and “high index layer” are interchangeable with the same meaning.

As used herein, the term “strengthened substrate” refers to a substrate employed in a cover article of the disclosure that has been strengthened in a manner that adds residual compressive stress. For example, strengthened substrates can be formed through ion-exchange of larger ions for smaller ions in the surface of the substrate. Further, other strengthening methods known in the art, such as thermal tempering, or utilizing a mismatch of the coefficient of thermal expansion between portions of the substrate to create compressive stress and central tension regions, may be utilized to form strengthened substrates.

As used herein, the term “transmittance” is defined as the percentage of incident optical power within a given wavelength range transmitted through a material (e.g., the cover article, the substrate, the outer layered film, or portions thereof). The term “reflectance” is similarly defined as the percentage of incident optical power within a given wavelength range that is reflected from a material (e.g., the cover article, the substrate, or the outer layered film, or portions thereof). Transmittance and reflectance are measured using a specific linewidth. As used herein, an “average transmittance” refers to the average amount of incident optical power transmitted through a material over a defined wavelength regime, e.g., “an optical wavelength regime”, as also defined herein from 400 nm to 700 nm. Unless otherwise noted, a suitable interval for average transmittance measurements is 5 nm. As used herein, an “average reflectance” refers to the average amount of incident optical power reflected by the material.

As used herein, “photopic reflectance” mimics the response of the human eye by weighting the reflectance or transmittance, respectively, versus wavelength spectrum according to the human eye's sensitivity. Photopic reflectance may also be defined as the luminance, or tri-stimulus Y value of reflected light, according to known conventions such as CIE color space conventions. The “average photopic reflectance” (Rₚ), as used herein, for a wavelength range from 380 nm to 720 nm is defined in the below equation as the spectral reflectance, R(λ) multiplied by the illuminant spectrum, I(λ) and the CIE's color matching function y̅(λ), related to the eye's spectral response given by Equation (1):

$$〈 {R}_{p} 〉 = {\int }_{380 nm}^{720 nm} R ( λ ) \times I ( λ ) \times \overline{y} ( λ ) d λ \qquad ( 1 )$$

In addition, “average reflectance” can be determined over the visible spectrum, or over other wavelength ranges, according to measurement principles understood by those skilled in the field of the disclosure. Unless otherwise noted, all reflectance values reported or otherwise referenced in this disclosure are associated with testing through the outer layered film of the cover articles and off of the primary surface of the substrate on which the outer layered film is disposed, e.g., a “first-surface” average photopic reflectance, a “first-surface” average reflectance over a specified range of wavelengths, etc.

The usability of a given display can be related to the total amount of reflectance in the display system. Photopic reflectance is particularly important for displays employed in vehicles. Lower reflectance in a display system or cover article over a display can reduce multiple-bounce reflections in the display system that can generate ‘ghost images’. Thus, reflectance has an important relationship to image quality in display systems.

As used herein, “photopic transmittance” (Tₚ) is defined in the below equation as the spectral transmittance, T(λ) multiplied by the illuminant spectrum, I(λ) and the CIE's color matching function y̅(λ), related to the eye's spectral response given by Equation (2):

$$〈 {T}_{p} 〉 = {\int }_{380 nm}^{720 nm} T ( λ ) \times I ( λ ) \times \overline{y} ( λ ) d λ \qquad ( 2 )$$

In addition, “average transmittance” can be determined over the visible spectrum or other wavelength ranges, according to measurement principles understood by those skilled in the field of the disclosure. Unless otherwise noted, all transmittance values reported or otherwise referenced in this disclosure are associated with testing through both primary surfaces of the substrate and the outer layered film of the cover articles, e.g., a “two-surface” average photopic transmittance, a “two-surface” average transmittance over a specified range of wavelengths, etc.

As noted above, the cover articles and materials of the disclosure are described in terms of their reflectance and transmittance properties. The cover articles and materials of the disclosure are also described in terms of their absorptance properties, as calculated or expressed from Equation (3):

Transmittance (T)=100%−Reflectance (R)−Absorptance (A) (3)

Hence, Equation (3) can be employed to calculate absorptance (A) values (interchangeably referred to in this disclosure as “absorption”) with as-measured transmittance (T) and reflectance (R) values.

The thickness and refractive index (n), and extinction coefficient (k) of the materials and articles disclosed herein, were determined using variable angle spectroscopic ellipsometry, unless indicated otherwise. Variable angle spectroscopic ellipsometry is based on Maxwell's equations and Fresnel reflection or transmission equations for polarized light, expressed in terms of Psi (Ψ) and Delta (Δ) according to Equation (4):

tan(Ψ)·e^{(iΔ)}=ρ=rₚ/rₛ (4)

where rₚ and rₛ are the complex Fresnel reflection coefficients of the sample for p-polarized light (in the plane of incidence) and s-polarized light (perpendicular to the plane of incidence), and where the complex ratio ρ is measured as a function of both wavelength and angle of incidence. Refractive index (n) and extinction coefficient (k) values reported herein were determined for light having a wavelength of 550 nm, unless otherwise reported. Additional information on variable angle spectroscopic ellipsometry can be found in an “Overview of Variable Angle Spectroscopic Ellipsometry (VASE), Part I: Basic Theory and Typical Applications,” Critical Reviews of Optical Science and Technology, Volume CR72, page 3-28, 1999. The examples in the present disclosure were analyzed using a W-200 spectroscopic ellipsometer from J. A. Woollam. It is understood that other instrumentation and methods, different working optical ranges, and/or different incident angles can also be employed to determine a thickness or an optical characteristic of the materials disclosed herein with any necessary scaling.

As used herein, “transmitted color” and “reflected color” refer to the color transmitted or reflected through the cover articles of the disclosure with regard to color coordinates (L*, a*, and b*) in the CIE L*, a*, b* colorimetry system under a D65 illuminant. Further, the “transmitted color” and “reflected color” can be given by the CIE L*, a*, b* color coordinates, as measured at a given, measuring incident angle (e.g., at 0 degrees (°), 45 degrees or 90 degrees) and/or over a measured, incident angle range, e.g., from 0 degrees to 10 degrees, from 0 degrees to 45 degrees, from 0 degrees to 90 degrees, etc.

To evaluate deadfront appearance, cover articles of the disclosure can be evaluated for their deadfront color shift (ΔE) according to Equation (5) as follows:

$$Δ E = \sqrt{{( {L}_{V A}^{*} - {L}_{B M}^{*} )}^{2} + {( {a}_{V A}^{*} - {a}_{B M}^{*} )}^{2} + {( {b}_{V A}^{*} - {b}_{B M}^{*} )}^{2}} \qquad ( 5 )$$

where L*_{VA}, a*_{VA}, and b*_{VA} are the CIE L*, a*, b* transmitted or reflected color coordinates of a portion of a display panel with the cover article of the disclosure and L*BM, a*BM, and b*BM are the CIE L*, a*, b* transmitted or reflected color coordinates of a portion of the display panel with comparative black matrix ink material. In particular, the comparative black matrix ink material is a polymer resin with the following color values: L*=4.79, a*=0.03 and b*=0.18. Further, as with transmitted color and reflected color values, the deadfront color shift (ΔE) can be evaluated and reported using various measurement incident angles and ranges (e.g., 0°, 45°, 90°, from 0° to 45°, etc.). Accordingly, the smaller the deadfront color shift (ΔE) value, the better the deadfront appearance of the given cover article sample.

Generally, the disclosure is directed to cover articles that employ an outer layered film and an inner layered film disposed on a glass substrate (e.g., Corning® Gorilla Glass® products), glass-ceramic substrate or ceramic substrate. These cover articles can exhibit semitransparency (e.g., 40-80% transmittance) and antireflective properties (e.g., a photopic reflectance<4%), and also exhibit a deadfront appearance (e.g., a low ΔE color shift, ΔE<4.0). In addition, the cover articles of the disclosure can exhibit suitable sheet resistance values to afford their use in capacitive, touchscreen applications.

Further, the cover articles of the disclosure can be manufactured in a manner in which all layers are deposited on one primary surface of the substrate using the same deposition apparatus (e.g., plasma-enhanced chemical vapor deposition, vacuum metallization, vacuum sputtering, etc.) in a single process sequence in a manner that reduces manufacturing costs over conventional deadfront configurations and processes. The cover articles of the disclosure can be employed for various display applications that benefit from a deadfront appearance (e.g., mobile phone displays, dashboard displays in vehicles, appliance displays, etc.).

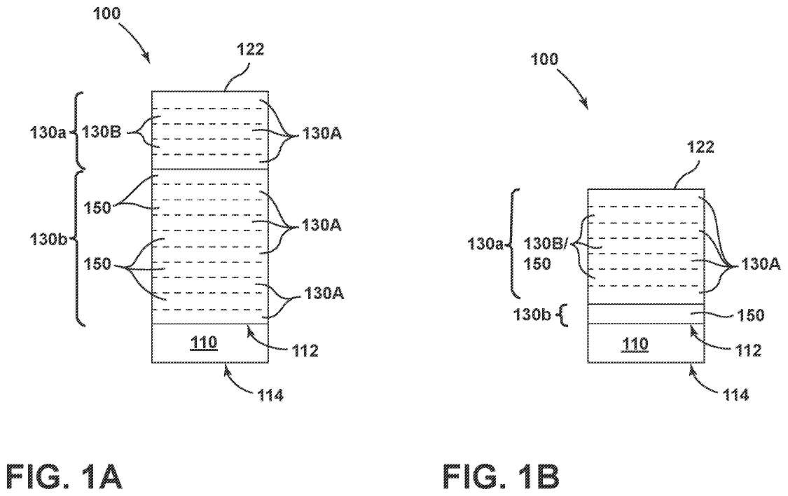

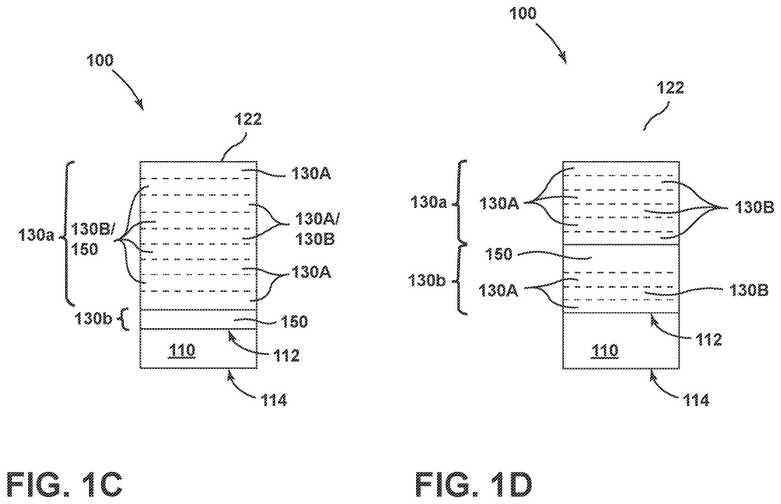

Reference will now be made in detail to various embodiments of cover articles (e.g., for display panel applications), examples of which are illustrated in the accompanying drawings of FIGS. 1A-1D. Referring to FIG. 1A, a cover article 100, according to one or more embodiments disclosed herein, may include a substrate 110, an inner layered film 130b disposed on the substrate and an outer layered film 130a disposed on the inner layered film 130b. The substrate 110 may include opposing primary surfaces 112, 114, and comprise a glass, glass-ceramic or ceramic material. The inner layered film 130b is shown in FIG. 1A as being disposed on an outer primary surface 112 and the outer layered film 130a on the inner layered film 130b; however, in some implementations, the outer and inner layered films 130a, 130b may be disposed on the inner primary surface 114 of the substrate 110, in addition to or instead of being disposed on the outer primary surface 112.

Referring again to FIG. 1A, the outer layered film 130a (also referred to herein as “antireflective layered film 130a” or “AR layered film 130a”) forms an outermost surface 122. Further, the outermost surface 122 of the outer layered film 130a may form an air-interface and generally defines the edge of the outer layered film 130a as well as the edge of the overall cover article 100 (e.g., when an additional coating, such as an easy-to-clean coating as described herein, is not disposed on the outer layered film 130a). The substrate 110 may be substantially transparent, as described herein.

The outer layered film 130a includes at least one layer of at least one material. The term “layer” may include a single layer or may include one or more sub-layers. Such sub-layers may be in direct contact with one another. The sub-layers may be formed from the same material or two or more different materials. In one or more alternative embodiments, such sub-layers may have intervening layers of different materials disposed therebetween. In one or more embodiments, a layer may include one or more contiguous and uninterrupted layers and/or one or more discontinuous and interrupted layers (i.e., a layer having different materials formed adjacent to one another). A layer or sub-layers may be formed by any known method in the art, including discrete deposition or continuous deposition processes. In one or more embodiments, the layer may be formed using only continuous deposition processes, or, alternatively, only discrete deposition processes.

The thickness of the outer layered film 130a may be about 0.25 μm or greater. In some examples, the thickness of the outer layered film 130a may be in the range from about 0.25 μm to about 20 μm, from about 0.25 μm to about 15 μm, from about 0.25 μm to about m, from about 0.25 μm to about 5 μm, from about 0.5 μm to about 10 μm, from about 0.5 m to about 5 μm, from about 0.5 μm to about 4 μm, and all thickness values of the outer layered film 130a between these thickness values. For example, the thickness of the outer layered film 130a can be about 0.25 μm, 0.3 μm, 0.4 μm, 0.5 μm, 0.6 μm, 0.7 μm, 0.8 μm, 0.9 μm, 1 μm, 1.25 μm, 1.5 μm, 1.75 μm, 2 μm, 3 μm, 4 μm, 5 μm, 6 μm, 7 μm, 8 μm, 9 μm, 10 μm, 12 μm, 14 μm, 16 μm, 18 μm, 20 μm, and all thickness values between these thicknesses.

As also shown in FIG. 1A, the outer layered film 130a includes a plurality of layers (130A, 130B). In one or more embodiments, the outer layered film 130a may include a period comprising two or more layers. The outer layered film 130a may include one or more of such periods. In one or more embodiments, the two or more layers may be characterized as having different refractive indices from each another. Each layer in each period may have physical thicknesses that are different from one another (i.e., corresponding layers in successive periods may have different physical thicknesses). In one embodiment, the period includes a first low RI layer 130A and a second high RI layer 130B. The difference in the refractive index of the first low RI layer 130A and the second high RI layer 130B may be about 0.01 or greater, about 0.05 or greater, about 0.1 or greater, or even about 0.2 or greater.

As shown in FIG. 1A, the cover article 100 can be configured, according to some embodiments, such that the outer layered film 130a may include a plurality of periods. A single period may include a first low RI layer 130A and a second high RI layer 130B, such that when a plurality of periods are provided, the first low RI layer 130A (designated for illustration as “L”) and the second high RI layer 130B (designated for illustration as “H”) alternate in the following sequence of layers: L/H/L/H or H/L/H/L, such that the first low RI layer 130A and the second high RI layer 130B appear to alternate along the physical thickness of the outer layered film 130a. In the example in FIG. 1A, the outer layered film 130a includes two (2) periods and one additional low RI layer 130A in the stack according to the following sequence: L/H/L/H/L. In some embodiments, the outer layered film 130a may include up to twenty-five (25) periods (also referred herein as “N” periods, in which N is an integer). For example, the outer layered film 130a may include from 2 to 20 periods (i.e., N=2-20), from 2 to 15 periods, from 2 to 12 periods, from 2 to 10 periods, from 2 to 12 periods, from 2 to 8 periods, from 2 to 6 periods, or any other period within these ranges. For example, the outer layered film 130a may include 1, 2, 3, 4, 5, 6, 7, 8, 9, 10, 11, 12, 13, 14, 15, 16, 17, 18, 19, 20, 21, 22, 23, 24 or 25 period(s).

Optionally, and as shown in exemplary form in FIG. 1A, an additional low RI layer 130A or a high RI layer 130B may be disposed on top of the periods of the outer layered film 130a and such that it is considered to be part of the outer layered film 130a stack (in such embodiments, the outer layered film 130a includes an odd number of layers, comprising a plurality of periods and an additional layer, with the additional layer being one of a low RI layer 130A and a high RI layer 130B).

A variety of configurations for the outer layered film 130a are contemplated herein. For example, as described herein with respect to FIG. 1B, the outer layered film 130a may include one or more absorber layers 150 that are used in place of at least one of the high RI layers 130B depicted in FIG. 1A. In another example, as described herein with respect to FIG. 1C, one or more absorber layers 150 may be incorporated into the outer layered film 130a. In such embodiments, the one or more absorber layers 150 may be disposed between two of the low RI layers 130A (i.e., in place of one of the high RI layers 130B depicted in FIG. 1A), between two of the high RI layers 130B (i.e., in place of one of the low RI layers 130A depicted in FIG. 1A), or between a high RI layer 130B and a low RI layer 130A. The outer layered film 130a may incorporate one or more absorber layers 150 at a variety of different locations and layer(s) 150 may be adjacent to a high RI layer 130B or a low RI layer 130A. Further, in some embodiments of the cover article 100, as shown in exemplary form in FIG. 1D, the outer layered film 130a does not include any absorber layers 150 (rather, in this embodiment, one or more absorber layers 150 are included in the inner layered film 130b).

As used herein, the terms “low RI” and “high RI” refer to the relative values for the refractive index of the layers 130A and 130B relative to one another (e.g., low RI<high RI). In one or more embodiments, the term “low RI” when used with the low RI layers 130A, includes a range from about 1.3 to about 1.7 or 1.75. In one or more embodiments, the term “high RI” when used with the high RI layers 130B, includes a range from about 1.7 to about 2.6 (e.g., about 1.85 or greater).

Materials suitable for use in the low RI layers 130A and high RI layers 130B of the outer layered film 130a include: SiO₂, Al₂O₃, GeO₂, SiO, AlOₓN_{y}, AlN, SiNₓ, SiOₓN_{y}, SiᵤAlᵥOₓN_{y}, Ta₂O₅, Nb₂O₅, TiO₂, ZrO₂, MgO, MgF₂, BaF₂, CaF₂, SnO₂, HfO₂, Y₂O₃, MoO₃, DyF₃, YbF₃, YF₃, CeF₃, polymers, fluoropolymers, plasma-polymerized polymers, siloxane polymers, silsesquioxanes, polyimides, fluorinated polyimides, polyetherimide, polyethersulfone, polyphenylsulfone, polycarbonate, polyethylene terephthalate, polyethylene naphthalate, acrylic polymers, urethane polymers, polymethylmethacrylate, other materials cited below as suitable for use in a scratch resistant layer, and other materials known in the art. Examples of suitable materials for use in the low RI layers 130A include SiO₂, Al₂O₃, GeO₂, SiO, AlOₓN_{y}, SiOₓN_{y}, SiᵤAlᵥOₓN_{y}, MgO, MgAl₂O₄, MgF₂, BaF₂, CaF₂, DyF₃, YbF₃, YF₃, and CeF₃. Examples of suitable materials for use in the high RI layers 130B include SiAlₓO_{y}N_{z}, Ta₂O₅, Nb₂O₅, AlNₓ, Si₃N₄, AlOₓN_{y}, SiOₓN_{y}, SiNₓ, SiNₓ:H_{y}, HfO₂, TiO₂, ZrO₂, Y₂O₃, Al₂O₃, MoO₃ and diamond-like carbon (DLC). In some embodiments of the cover article 100, each low RI layer 130A comprises SiO or SiO₂ and each high RI layer 130B comprises SiNₓ, Si3N₄ or Nb₂O₅.

Referring again to the cover article 100 depicted in exemplary form in FIGS. 1A-1D, inner layered film 130b is disposed on the primary surface 112 of the substrate 110. In embodiments, the inner layered film 130b includes a plurality of low refractive index layers 130A and absorber layers 150. These layers 130A and 150 can be arranged in various sequences within the inner layered film 130b, including in an alternating fashion, as shown in FIG. 1A. In some implementations, the inner layered film 130b includes one absorber layer 150 (see cover article 100 depicted in FIGS. 1B-1D, described below) or multiple absorber layers 150 (see cover article 100 depicted in FIG. 1A). In some embodiments, the inner layered film 130b includes 1 to 20, 2 to 20, 2 to 15, or 2 to 10 absorber layers 150; or, the inner layered film 130b may contain any number of absorber layers 150 in the foregoing ranges.

The absorber layers 150 employed in one or both of the outer layered film 130a and the inner layered film 130b are generally configured to ensure that the cover article 100 (see FIGS. 1A-1D) exhibits semitransparency, can be employed in touchscreen applications, and can facilitate antireflective properties. Further, absorber layers 150 are configured in the outer and inner layered films 130a, 130b in the embodiments of the cover articles 100 so that these films are amenable to manufacturing processes and apparatus that can form the outer layered film 130a and inner layered film 130b in a single process sequence with the same apparatus.

With regard to touchscreen capability, the absorber layers 150 of the cover article 100 (see FIGS. 1A-1D) should be at least somewhat electrically resistive. In embodiments, each of the absorber layers 150 of the cover article 100 exhibits a sheet resistance of at least 10⁵ Ohms/sq, 5×10⁵ Ohms/sq, 10⁶ Ohms/sq, or even 10⁷ Ohms/sq. For example, each of the absorber layers 150 can exhibit a sheet resistance of 10⁵ Ohms/sq, 5×10⁵ Ohms/sq, 10⁶ Ohms/sq, 5×10⁶ Ohms/sq, 10⁷ Ohms/sq, 5×10⁷ Ohms/sq, and all sheet resistance values between these levels.

With regard to semitransparency of the cover article 100 (see FIGS. 1A-1D), embodiments can be configured such that each absorber layer 150 exhibits a requisite degree of optical absorptance. In some embodiments, each absorber layer 150 for single absorber layer embodiments, or the total number of absorber layers 150 for multi-absorber layer embodiments, exhibits an average absorptance of 1% to 60%, 2% to 60%, or 3% to 50%, and all absorptance values between the foregoing, as measured in the visible spectrum from 400 nm to 700 nm. In implementations, each of the absorber layers 150 exhibits an extinction coefficient (k) of greater than 0.5, 0.75, 1.0, 1.5, 2.0, 3.0 or even 4.0 in the visible spectrum from 400 nm to 700 nm. In some implementations of the cover article 100, each of the absorber layers 150 exhibits an extinction coefficient (k) from about 0.05 to about 0.4, from about 0.05 to about 0.35, or from about 0.05 to about 0.3, all as measured in the visible spectrum from 400 nm to 700 nm. For example, each absorber layer 150 employed in the cover articles of the disclosure can exhibit an extinction coefficient of 0.05, 0.1, 0.15, 0.2, 0.3, 0.4, 0.5, 0.75, 1.0, 2.0, 3.0, 4.0, 5.0, 7.5, 10.0, and all extinction coefficient values between the foregoing values.

The absorber layers 150 employed in the cover articles 100 of the disclosure, as depicted in exemplary form in FIGS. 1A-1D, can comprise various materials, e.g., as suitable to exhibit the foregoing properties. In the cover article 100 depicted in FIG. 1A, for example, each of the absorber layers 150 can comprise Ni, Cr, a Ni-containing alloy, a Cr-containing alloy, or a Ni/Cr alloy. In some embodiments, each absorber layer 150 of the cover article 100 comprises Cr. In some embodiments, each absorber layer 150 of the cover article 100 comprises Ni. In other implementations of the cover article 100, for example as shown in FIGS. 1B and 1C, each absorber layer 150 can comprise a diamond-like carbon (DLC) material. Any of various DLC materials known by those skilled in the field of the disclosure can be employed in the absorber layers 150 of these cover articles 100. In further implementations of the cover article 100, for example as shown in FIG. 1D, each absorber layer 150 is a silicon-metal alloy that comprises Si and Al, Sn or Zn. In some of these implementations, the absorber layer 150 does not contain any silicides. Further, according to some embodiments, absorber layers 150 comprising Si—Al have 69% or more Si (by volume); absorber layers 150 comprising Si—Sn have 60% or more Si; and absorber layers 150 comprising Si—Zn have 80% or more Si.

Further, according to some embodiments, the foregoing materials of the absorber layers 150 can be deposited with the same processes and apparatus suitable for depositing the other layers of the outer and inner layered films 130a, 130b (e.g., low RI layers 130A and high RI layers 130B), including but not limited to plasma-enhanced chemical vapor deposition (PECVD), vacuum sputtering, vacuum metallization magnetron sputtering, filtered cathode vacuum arc (FCVA), ion beam deposition, ion beam sputtering, and other deposition processes.

The thicknesses of the absorber layers 150 employed in the cover articles 100, e.g., as depicted in FIG. 1A, of the disclosure can also be tailored to achieve the targeted article-level properties and absorber layer properties. In some implementations, each of the absorber layers 150 of the inner layered film 130b of the cover article 100 (see FIG. 1A) comprising Ni, Cr or combinations thereof has a thickness of less than 2 nm, 1.8 nm, 1.6 nm, 1.4 nm, 1.2 nm, or 1.0 nm. For absorber layers 150 comprising Cr, the thickness of each of these layers can be less than 2.0 nm, according to some embodiments. For absorber layers 150 comprising Ni, the thickness of each of these layers can be less than 1.0 nm, according to some embodiments. Essentially, metal-containing absorber layers 150 can be limited in thickness as such layers with thicknesses that exceed a percolation threshold can exhibit coalescence of material in a manner that results in decreased sheet resistance levels making such articles that contain them not suitable for capacitive touchscreen applications. Accordingly, embodiments of cover articles 100 with such absorber layers 150 can be configured such that each absorber layer 150, depending on which metal it is made of, maintains a thickness below its percolation threshold.

The thicknesses of the absorber layers 150 employed in the cover articles 100, e.g., as depicted in FIGS. 1B and 1C, of the disclosure can also be tailored to achieve the targeted article-level properties and absorber layer properties. In some implementations, each of the absorber layers 150 of the inner layered film 130b of the cover article 100 (see FIGS. 1B and 1C) comprising DLC material can have a thickness from about 5 nm to 500 nm, 25 nm to 500 nm, or even 50 nm to 500 nm. For example, each absorber layer 150 comprising a DLC material can have a thickness of about 5 nm, 10 nm, 15 nm, 20 nm, 25 nm, 50 nm, 75 nm, 100 nm, 125 nm, 150 nm, 175 nm, 200 nm, 250 nm, 300 nm, 350 nm, 400 nm, 450 nm, or even 500 nm, and all thickness values between these values. In comparison to absorber layers 150 comprising metals or metal alloys, these absorber layers 150 comprising DLC material can advantageously be thicker without sacrificing sheet resistance. However, the practical thickness of absorber layers 150 comprising DLC material can be limited in terms of resistance to layer cracking (e.g., from thermal stress), and/or packaging considerations in which thicker overall structures are not feasible in the given end-use application.

The thicknesses of the absorber layers 150 employed in the cover articles 100, e.g., as depicted in FIG. 1D, of the disclosure can also be tailored to achieve the targeted article-level properties and absorber layer properties. In some implementations, each of the absorber layers 150 of the inner layered film 130b of the cover article 100 (see FIG. 1D) comprising Si—Al, Si—Sn, Si—Zn or combinations thereof has a thickness of less than 150 nm, 140 nm, 130 nm, 120 nm, 110 nm, 100 nm, 80 nm, 60 nm, 50 nm, 40 nm, 30 nm, 20 nm, 15 nm, or 10 nm. For example, each of absorber layers 150 comprising a silicon-aluminum, silicon-tin or silicon-zinc alloy can have a thickness of 145 nm, 140 nm, 135 nm, 130 nm, 125 nm, 115 nm, 105 nm, 100 nm, 90 nm, 75 nm, 50 nm, 25 nm, 10 nm, 8 nm, 6 nm, 5 nm, 2.5 nm, and all thickness values less than 150 nm. Essentially, Si—Al, Si—Sn and Si—Zn absorber layers 150 can be limited in thickness as such layers with thicknesses that exceed a percolation threshold can exhibit coalescence of material in a manner that results in decreased sheet resistance levels making such articles that contain them not suitable for capacitive touchscreen applications. Accordingly, embodiments of cover articles 100 with such absorber layers 150 can be configured such that each absorber layer 150, depending on which metal it is made of, maintains a thickness below its percolation threshold.

In one or more embodiments, at least one of the layer(s) of the outer and inner layered films 130a, 130b (e.g., low RI layers 130A, high RI layers 130B and absorber layers 150) may include a specific optical thickness range. As used herein, the term “optical thickness” is determined by the product of the physical thickness (d) and the refractive index (n) of a layer at a wavelength of 550 nm. In one or more embodiments, at least one of the layers of the outer layered film 130a may include an optical thickness in the range from about 2 nm to about 200 nm, from about 10 nm to about 100 nm, from about 15 nm to about 100 nm, or from about 15 to about 500 nm. In some embodiments, all of the layers in the outer layered film 130a may each have an optical thickness in the range from about 2 nm to about 200 nm, from about 10 nm to about 100 nm, from about 15 nm to about 100 nm, or from about 15 nm to about 500 nm. In some cases, one or more layers of the outer and inner layered films 130a, 130b has an optical thickness of about 50 nm or greater. In some cases, each of the low RI layers 130A has an optical thickness in the range from about 2 nm to about 200 nm, from about 10 nm to about 100 nm, from about 15 nm to about 100 nm, or from about 15 nm to about 500 nm. In other cases, each of the high RI layers 130B has an optical thickness in the range from about 2 nm to about 200 nm, from about 10 nm to about 100 nm, or from about 15 nm to about 100 nm.

In some embodiments of the cover articles 100 of the disclosure, the outermost surface 122 of the outer layered film 130a may comprise a high RI layer 130B (not shown) that also exhibits high hardness. In some embodiments, an additional coating (not shown) may be disposed on top of an exposed, top-most air-side high RI layer 130B or an additional coating may be disposed on top of the top-most low RI layer 130A (as shown in FIGS. 1A-1D). Such an additional coating may include a low-friction coating, an oleophobic coating, or an easy-to-clean coating, as understood by those skilled in the field of the disclosure.

In an embodiment, the cover article 100 includes one or more additional coatings disposed on the outer layered film 130a (not shown in FIGS. 1A-1D). In one or more embodiments, the additional coating may include an easy-to-clean coating. An example of a suitable easy-to-clean coating is described in U.S. patent application Ser. No. 13/690,904, entitled “Process for Making of Glass Articles with Optical and Easy-to-Clean Coatings,” filed on Nov. 30, 2012, and published as U.S. Patent Application Publication No. 2014/0113083 on Apr. 24, 2014, and the salient portions of this application are incorporated by reference herein in their entirety. The easy-to-clean coating may have a thickness in the range from about 5 nm to about 50 nm and may include known materials such as fluorinated silanes. The easy-to-clean coating may alternately or additionally comprise a low-friction coating or surface treatment. Exemplary low-friction coating materials may include diamond-like carbon, silanes (e.g., fluorosilanes), phosphonates, alkenes, and alkynes. In some embodiments, the easy-to-clean coating may have a thickness in the range from about 1 nm to about 40 nm, from about 1 nm to about 30 nm, from about 1 nm to about 25 nm, from about 1 nm to about 20 nm, from about 1 nm to about 15 nm, from about 1 nm to about 10 nm, from about 5 nm to about 50 nm, from about 10 nm to about 50 nm, from about 15 nm to about 50 nm, from about 7 nm to about 20 nm, from about 7 nm to about 15 nm, from about 7 nm to about 12 nm or from about 7 nm to about 10 nm, and all ranges and sub-ranges therebetween.

The additional coating employed in such cover articles 100 may also include a scratch resistant layer or layers, again as understood by those skilled in the field of the disclosure, typically made of a material comparable to the high RI layers 130B. In some embodiments, the additional coating includes a combination of easy-to-clean material and scratch resistant material. In one example, the combination includes an easy-to-clean material and diamond-like carbon. Such additional coatings may have a thickness in the range from about 5 nm to about 20 nm. The constituents of the additional coating may be provided in separate layers. For example, the diamond-like carbon may be disposed as a first layer and the easy-to clean material can be disposed as a second layer on the first layer of diamond-like carbon. The thicknesses of the first layer and the second layer may be in the ranges provided above for the additional coating. For example, the first layer of diamond-like carbon may have a thickness of about 1 nm to about 20 nm or from about 4 nm to about 15 nm (or more specifically about 10 nm) and the second layer of easy-to-clean material may have a thickness of about 1 nm to about 10 nm (or more specifically about 6 nm). The diamond-like coating may include tetrahedral amorphous carbon (Ta—C), Ta—C:H, and/or a-C—H.

In one implementation of the embodiment of the cover article 100, as depicted in FIG. 1A, the cover article 100 includes: a substrate 110 comprising a thickness from 50 μm to 5000 μm, an outer primary surface 112 and an inner primary surface 114, wherein the outer and inner primary surfaces 112, 114 are opposite of one another and the substrate 110 comprises a glass, glass-ceramic or ceramic material. The cover article 100 also includes an inner layered film 130b disposed on the outer primary surface 112 of the substrate 110; and an outer layered film 130a disposed on the inner layered film 130b. The inner layered film 130b comprises a plurality of low refractive index layers 130A and absorber layers 150. The outer layered film 130a comprises a plurality of alternating high refractive index layers 130B and low refractive index layers 130A. Each of the high refractive index layers 130B has a refractive index greater than a refractive index of each of the low refractive index layers 130A. In addition, each absorber layer 150 comprises a metal or a metal alloy. Further, in such embodiments, each absorber layer 150 exhibits a sheet resistance of at least 10⁵ Ohms/sq and an extinction coefficient of greater than 0.5 in the visible spectrum from 400 nm to 700 nm.

In some embodiments of the cover article 100, as depicted in exemplary form in FIG. 1A, the outer layered film 130a includes two sets of alternating low RI layers 130A (e.g., SiO₂) and high RI layers 130B (e.g., SiNₓ), and an additional low RI layer 130A (SiO₂) disposed on the top-most high RI layer 130B. Further, the inner layered film 130b includes five sets of alternating low RI layers 130A (SiO₂) and absorber layers 150 (Ni or Cr). Alternative embodiments may include more or less low RI layers 130A, high RI layers 130B and/or absorber layers 150.

In embodiments, such as those depicted in FIGS. 1B, 1C and 1D, the cover article 100 includes an outer layered film 130a and an inner layered film 130b having different configurations of absorber layers 150 than described above with respect to the cover article 100 of FIG. 1A. FIG. 1B depicts a cover article 100 where the inner layered film 130b includes an absorber layer 150 and the outer layered film 130a includes one or more absorber layers 150 placed adjacent to the low RI layers 130A (such that the absorber layer 150 is not disposed adjacent to any of the other high RI layers 130B in the outer layered film 130a), while FIG. 1C depicts an embodiment where the inner layered film 130b includes an absorber layer 150 and the outer layered film 130a includes one or more absorber layers 150 that may be placed adjacent a low RI layer 130A, a high RI layer 130B, and/or both a low RI layer 130A and a high RI layer 130B. As described herein, in the embodiments of the cover article 100 depicted in FIGS. 1B and 1C, at least one of the absorber layers 150 contained in the cover article 100 is a DLC layer. Further, FIG. 1C depicts a cover article 100 where the inner layered film 130b includes one absorber layer 150 adjacent to a low RI layer 130A and the outer layered film 130a includes a plurality of alternating low RI layers 130A and high RI layers 130B with a high RI layer 130B in contact with the absorber layer 150 of the inner layered film 130b. As described herein, in the embodiments of the cover article 100 depicted in FIG. 1D, at least one absorber layer 150 contained in the cover article 100 comprises a Si—Al, Si—Sn or Si—Zn alloy.

Referring generally to FIGS. 1B and 1C, the cover article 100 can include: a substrate 110 comprising a thickness from 50 μm to 5000 μm, an outer primary surface 112 and an inner primary surface 114, wherein the outer and inner primary surfaces 112, 114 are opposite of one another and the substrate 110 comprises a glass, glass-ceramic or ceramic material. The cover article 100 also includes an inner layered film 130b disposed on the outer primary surface 112 of the substrate 110; and an outer layered film 130a disposed on the inner layered film 130b. One or both of the inner layered film 130b and the outer layered film 130a comprises one or more absorber layers 150. The outer layered film 130a comprises a plurality of alternating high refractive index layers 130B and low refractive index layers 130A. Each of the high refractive index layers 130B has a refractive index greater than a refractive index of each of the low refractive index layers 130A. In addition, each absorber layer 150 comprises a diamond-like carbon (DLC) material. Further, in such embodiments, each absorber layer 150 exhibits a sheet resistance of at least 10⁵ Ohms/sq and an extinction coefficient from about 0.05 to about 0.4 in the visible spectrum from 400 nm to 700 nm.

In some embodiments of the cover article 100, as depicted in exemplary form in FIG. 1B, the outer layered film 130a includes three sets of alternating layers, with each set comprising a low RI layer 130A (e.g., SiO₂) or a high RI layer 130B (e.g., Nb₂O₅) with an absorber layer 150 (DLC material) or a high RI layer 130B disposed thereon. The outer layered film 130a also includes an additional low RI layer 130A (SiO₂) disposed on the top-most high RI layer 130B or absorber layer 150 of one of the sets of alternating layers. Further, the inner layered film 130b includes an additional absorber layer 150 (DLC material).

In other implementations of the cover article 100, as depicted in exemplary form in FIG. 1C, the outer layered film 130a includes four sets of alternating low RI layers 130A (e.g., SiO₂) or high RI layers 130; and high RI layers 130B (e.g., Nb₂O₅) and/or absorber layers 150 (DLC material), and an additional low RI layer 130A (SiO₂) disposed on the top-most high RI layer 130B or absorber layer 150. Further, the inner layered film 130b includes an additional absorber layer 150 (DLC material).

Referring generally to FIG. 1D, the cover article 100 can include: a substrate 110 comprising a thickness from 50 μm to 5000 μm, an outer primary surface 112 and an inner primary surface 114, wherein the outer and inner primary surfaces 112, 114 are opposite of one another and the substrate 110 comprises a glass, glass-ceramic or ceramic material. The cover article 100 also includes an inner layered film 130b disposed on the outer primary surface 112 of the substrate 110; and an outer layered film 130a disposed on the inner layered film 130b. The inner layered film 130b can comprise one or more absorber layers 150. The outer layered film 130a comprises a plurality of alternating high refractive index layers 130B and low refractive index layers 130A. Each of the high refractive index layers 130B has a refractive index greater than a refractive index of each of the low refractive index layers 130A. In addition, each absorber layer 150 in the cover article 100 depicted in FIG. 1D comprises a silicon-metal alloy, such as Si—Al, Si—Sn, Si—Zn or combinations thereof. Further, in such embodiments, each absorber layer 150 exhibits a sheet resistance of at least 10⁵ Ohms/sq and an extinction coefficient from about 0.05 to about 0.4 in the visible spectrum from 400 nm to 700 nm.

In some embodiments of the cover article 100, as depicted in exemplary form in FIG. 1D, the outer layered film 130a includes three sets of alternating layers, with each set comprising a low RI layer 130A (e.g., SiO₂) and a high RI layer 130B (e.g., Nb₂O₅). As shown in exemplary form in FIG. 1D, the outer layered film 130 can be configured such that it has an outermost low RI layer 130A defining the outermost surface 122 and innermost high RI layer 130B in contact with the top-most layer of the inner layered film 130b. Further, the inner layered film 130b includes an absorber layer 150 (e.g., a Si—Al, Si—Sn or Si—Zn alloy) as its topmost layer, along with a sequence of low RI layers 130A and a high RI layer 130B between the absorber layer 150 and the substrate 110.

According to embodiments of the cover article 100 of the disclosure, as depicted in exemplary form in FIGS. 1A-1D, the cover article 100 exhibits a first-surface average photopic reflectance of less than 4%, e.g., at a normal angle of incidence of 0° or a near-normal angle of incidence of 8°. In embodiments, the cover article 100 can exhibit a first-surface average photopic reflectance of less than 4%, less than 3%, less than 2%, less than 1.75%, less than 1.5%, less than 1.25%, or even less than 1.2%. For example, the cover article 100 can exhibit a first-surface average photopic reflectance of 3.9%, 3.7%, 3.5%, 3.3%, 3.1%, 3.0%, 2.5%, 2%, 1.9%, 1.8%, 1.7%, 1.6%, 1.5%, 1.4%, 1.3%, 1.2%, 1.1%, 1.0%, 0.9%, 0.8%, 0.7%, 0.6%, 0.5%, 0.4%, 0.3%, and all reflectance values between the foregoing ranges and sub-ranges, at normal and near-normal incidence angles from 0° to 8°.

According to embodiments of the cover article 100 of the disclosure, as depicted in exemplary form in FIGS. 1A-1D, the cover article 100 exhibits a two-surface average transmittance of from 30% to 80%, 40% to 80%, 45% to 75%, or from 50% to 70%, in the visible spectrum from 400 nm to 700 nm, e.g., at a normal angle of incidence of 0° or a near-normal angle of incidence of 8°. For example, the cover article 100 can exhibit a two-surface average transmittance in the visible spectrum from 400 nm to 700 nm of 30%, 35%, 40%, 45%, 50%, 55%, 60%, 65%, 70%, 75%, 80%, and all transmittance values between the foregoing ranges and sub-ranges, e.g., at a normal angle of incidence of 0° or a near-normal angle of incidence of 8°.

According to embodiments of the cover article 100 of the disclosure, as depicted in exemplary form in FIGS. 1A-1D, the cover article 100 exhibits a first-surface reflected or two-surface transmitted color (CIE coordinates under illumination from a D65 illuminant) for all angles of incidence from 0° to 90° with a* from −20 to +50 and b* from −50 to +10. In some implementations of the cover article 100 of the disclosure, the first-surface reflected color or two-surface transmitted color for all angles of incidence from 0° to 90° is such that a* is from −20 to +50, or −10 to +40; and that b* is from −50 to +10, or −45 to 0, or −40 to −10.

According to embodiments of the cover article 100 of the disclosure, as depicted in exemplary form in FIGS. 1A-1D, the cover article 100 exhibits a deadfront color shift (ΔE) of less than 4.0, less than 3.5, or even less than 3.0, for incident, measuring angles from 0° to 90°, as measured relative to a control article comprising the glass, glass-ceramic or ceramic material of the substrate 110 and a standard black matrix material (as known by those skilled in the field of the disclosure) disposed on the glass, glass-ceramic or ceramic material of the control article (otherwise fabricated identically to the cover article 100). For example, the cover articles 100 of the disclosure can exhibit a deadfront color shift (ΔE) of 3.9, 3.7, 3.5, 3.3, 3.1, 2.9, 2.7, 2.5, 2.3, 2.1, 1.9, 1.7, 1.5, and all deadfront color shift values between the foregoing values, as measured at incident angles from 0° to 90°.

The substrate 110 may include an inorganic material and may include an amorphous substrate, a crystalline substrate, or a combination thereof. The substrate 110 may be formed from man-made materials and/or naturally occurring materials (e.g., quartz and polymers). For example, in some instances, the substrate 110 may be characterized as organic and may specifically be polymeric. Examples of suitable polymers include, without limitation: thermoplastics including polystyrene (PS) (including styrene copolymers and blends), polycarbonate (PC) (including copolymers and blends), polyesters (including copolymers and blends, including polyethyleneterephthalate and polyethyleneterephthalate copolymers), polyolefins (PO) and cyclicpolyolefins (cyclic-PO), polyvinylchloride (PVC), acrylic polymers including polymethyl methacrylate (PMMA) (including copolymers and blends), thermoplastic urethanes (TPU), polyetherimide (PEI) and blends of these polymers with each other. Other exemplary polymers include epoxy, styrenic, phenolic, melamine, and silicone resins.

In some specific embodiments, the substrate 110 may specifically exclude polymeric, plastic and/or metal materials. The substrate 110 may be characterized as alkali-including substrates (i.e., the substrate includes one or more alkalis). In one or more embodiments, the substrate 110 exhibits a refractive index in the range from about 1.45 to about 1.55. In specific embodiments, the substrate 110 may exhibit an average strain-to-failure at a surface on one or more opposing primary surfaces that is 0.5% or greater, 0.6% or greater, 0.7% or greater, 0.8% or greater, 0.9% or greater, 1% or greater, 1.1% or greater, 1.2% or greater, 1.3% or greater, 1.4% or greater 1.5% or greater or even 2% or greater, as measured using ball-on-ring testing using at least 5, at least 10, at least 15, or at least 20 samples. In specific embodiments, the substrate 110 may exhibit an average strain-to-failure at its surface on one or more opposing primary surfaces of about 1.2%, about 1.4%, about 1.6%, about 1.8%, about 2.2%, about 2.4%, about 2.6%, about 2.8%, or about 3% or greater.

Suitable substrates 110 may exhibit an elastic modulus (or Young's modulus) in the range from about 30 GPa to about 120 GPa. In some instances, the elastic modulus of the substrate may be in the range from about 30 GPa to about 110 GPa, from about 30 GPa to about 100 GPa, from about 30 GPa to about 90 GPa, from about 30 GPa to about 80 GPa, from about 30 GPa to about 70 GPa, from about 40 GPa to about 120 GPa, from about 50 GPa to about 120 GPa, from about 60 GPa to about 120 GPa, from about 70 GPa to about 120 GPa, and all ranges and sub-ranges therebetween.

In one or more embodiments, the substrate 110 may include glass, which may be strengthened or non-strengthened. Examples of suitable glass include soda lime glass, alkali aluminosilicate glass, alkali containing borosilicate glass and alkali aluminoborosilicate glass. In some variants, the glass may be free of lithia. In one or more alternative embodiments, the substrate 110 may include crystalline substrates such as glass-ceramic substrates (which may be strengthened or non-strengthened) or may include a single crystal structure, such as sapphire. In one or more specific embodiments, the substrate 110 includes an amorphous base (e.g., glass) and a crystalline cladding (e.g., sapphire layer, a polycrystalline alumina layer and/or or a spinel (MgAl₂O₄) layer).

The substrate 110 may be substantially optically clear, transparent and free from light scattering elements. In such embodiments, the substrate 110 may exhibit an average light transmittance over the optical wavelength regime of about 85% or greater, about 86% or greater, about 87% or greater, about 88% or greater, about 89% or greater, about 90% or greater, about 91% or greater, or about 92% or greater for light normally incident thereon. In one or more alternative embodiments, the substrate 110 may be opaque or exhibit an average light transmittance over the optical wavelength regime of less than about 10%, less than about 9%, less than about 8%, less than about 7%, less than about 6%, less than about 5%, less than about 4%, less than about 3%, less than about 2%, less than about 1%, or less than about 0.5%. In some embodiments, these light reflectance and transmittance values may be a total reflectance or total transmittance (taking into account reflectance or transmittance on both primary surfaces of the substrate) or may be observed on a single side of the substrate (i.e., on the outermost surface 122 of the outer layered film 130a only, without taking into account the opposite surface). Unless otherwise specified, the average reflectance or transmittance of the substrate 110 alone is measured at an incident illumination angle of 0 degrees relative to the substrate primary surface 112 (however, such measurements may be provided at incident illumination angles of 45 degrees or 60 degrees). The substrate 110 may optionally exhibit a color, such as white, black, red, blue, green, yellow, orange, etc.

Additionally or alternatively, the physical thickness of the substrate 110 may vary along one or more of its dimensions for aesthetic and/or functional reasons. For example, the edges of the substrate 110 may be thicker as compared to more central regions of the substrate 110. The length, width and physical thickness dimensions of the substrate 110 may also vary according to the application or use of the cover article 100.

The substrate 110 may be provided using a variety of different processes. For instance, where the substrate 110 includes an amorphous substrate such as glass, various forming methods can include float glass processes and down-draw processes such as fusion draw and slot draw.

Once formed, a substrate 110 may be strengthened to form a strengthened substrate. As used herein, the term “strengthened substrate” may refer to a substrate that has been chemically strengthened, for example through ion-exchange of larger ions for smaller ions in the surface of the substrate. However, other strengthening methods known in the art, such as thermal tempering, or utilizing a mismatch of the coefficient of thermal expansion between portions of the substrate to create compressive stress and central tension regions, may be utilized to form strengthened substrates.

Where the substrate 110 is chemically strengthened by an ion exchange process, the ions in the surface layer of the substrate are replaced by—or exchanged with—larger ions having the same valence or oxidation state. Ion exchange processes are typically carried out by immersing a substrate in a molten salt bath containing the larger ions to be exchanged with the smaller ions in the substrate. It will be appreciated by those skilled in the art that parameters for the ion exchange process, including, but not limited to, bath composition and temperature, immersion time, the number of immersions of the substrate in a salt bath (or baths), use of multiple salt baths, and additional steps such as annealing, washing, and the like, are generally determined by the composition of the substrate and the desired compressive stress (CS), depth of compressive stress layer (or depth of layer DOL, or depth of compression DOC) of the substrate that result from the strengthening operation. By way of example, ion exchange of alkali metal-containing glass substrates may be achieved by immersion in at least one molten bath containing a salt such as, but not limited to, nitrates, sulfates, and chlorides of the larger alkali metal ion. The temperature of the molten salt bath typically is in a range from about 380° C. up to about 450° C., while immersion times range from about 15 minutes up to about 40 hours. However, temperatures and immersion times different from those described above may also be used.

In addition, non-limiting examples of ion exchange processes in which glass substrates are immersed in multiple ion exchange baths, with washing and/or annealing steps between immersions, are described in U.S. patent application Ser. No. 12/500,650, filed Jul. 10, 2009, by Douglas C. Allan et al., entitled “Glass with Compressive Surface for Consumer Applications” and claiming priority from U.S. Provisional Patent Application No. 61/079,995, filed Jul. 11, 2008, in which glass substrates are strengthened by immersion in multiple, successive, ion exchange treatments in salt baths of different concentrations; and U.S. Pat. No. 8,312,739, by Christopher M. Lee et al., issued on Nov. 20, 2012, and entitled “Dual Stage Ion Exchange for Chemical Strengthening of Glass,” and claiming priority from U.S. Provisional Patent Application No. 61/084,398, filed Jul. 29, 2008, in which glass substrates are strengthened by ion exchange in a first bath diluted with an effluent ion, followed by immersion in a second bath having a smaller concentration of the effluent ion than the first bath. The contents of U.S. patent application Ser. No. 12/500,650 and U.S. Pat. No. 8,312,739 are incorporated herein by reference in their entirety.

The degree of chemical strengthening achieved by ion exchange may be quantified based on the parameters of central tension (CT), surface CS, and depth of compression (DOC). Compressive stress (including surface CS) is measured by a surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety. Maximum CT values are measured using a scattered light polariscope (SCALP) technique known in the art. As used herein, DOC means the depth at which the stress in the chemically strengthened alkali aluminosilicate glass article described herein changes from compressive to tensile. DOC may be measured by FSM or SCALP depending on the ion exchange treatment. Where the stress in the glass article is generated by exchanging potassium ions into the glass article, FSM is used to measure DOC. Where the stress is generated by exchanging sodium ions into the glass article, SCALP is used to measure DOC. Where the stress in the glass article is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass articles is measured by FSM.

In one embodiment, a substrate 110 can have a surface CS of 250 MPa or greater, 300 MPa or greater, e.g., 400 MPa or greater, 450 MPa or greater, 500 MPa or greater, 550 MPa or greater, 600 MPa or greater, 650 MPa or greater, 700 MPa or greater, 750 MPa or greater or 800 MPa or greater. The strengthened substrate may have a DOC (formerly DOL) of 10 μm or greater, 15 μm or greater, 20 μm or greater (e.g., 25 μm, 30 μm, 35 μm, 40 μm, 45 μm, 50 μm or greater) and/or a CT of 10 MPa or greater, 20 MPa or greater, 30 MPa or greater, 40 MPa or greater (e.g., 42 MPa, 45 MPa, or 50 MPa or greater) but less than 100 MPa (e.g., 95, 90, 85, 80, 75, 70, 65, 60, 55 MPa or less). In one or more specific embodiments, the strengthened substrate has one or more of the following: a surface CS greater than 500 MPa, a DOC (formerly DOL) greater than 15 μm, and a CT greater than 18 MPa.

Example glasses that may be used in the substrate 110 may include alkali aluminosilicate glass compositions or alkali aluminoborosilicate glass compositions, though other glass compositions are contemplated. Such glass compositions are capable of being chemically strengthened by an ion exchange process. One example glass composition comprises SiO₂, B₂O₃ and Na₂O, where (SiO₂+B₂O₃)≥66 mol. %, and Na₂O≥9 mol. %. In an embodiment, the glass composition includes at least 6 wt. % aluminum oxide. In a further embodiment, the substrate includes a glass composition with one or more alkaline earth oxides, such that a content of alkaline earth oxides is at least 5 wt. %. Suitable glass compositions, in some embodiments, further comprise at least one of K₂O, MgO, and CaO. In a particular embodiment, the glass compositions used in the substrate can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition suitable for the substrate 110 comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)≤10 mol. %.

A still further example glass composition suitable for the substrate 110 comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %.

In a particular embodiment, an alkali aluminosilicate glass composition suitable for the substrate 110 comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio (Al₂O₃+B₂O₃)/Σ modifiers (i.e., sum of modifiers) is greater than 1, where in the ratio the components are expressed in mol. % and the modifiers are alkali metal oxides. This glass composition, in particular embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio (Al₂O₃+B₂O₃)/Σ modifiers (i.e., sum of modifiers) is greater than 1.

In still another embodiment, the substrate 110 may include an alkali aluminosilicate glass composition comprising: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≤SiO₂+B₂O₃+CaO≤69 mol. %; Na₂O+K₂O+B₂O₃+MgO+CaO+SrO>10 mol. %; 5 mol. % MgO+CaO+SrO≤8 mol. %; (Na₂O+B₂O₃)—Al₂O₃≤2 mol. %; 2 mol. %≤Na₂O—Al₂O₃≤6 mol. %; and 4 mol. %≤(Na₂O+K₂O)—Al₂O₃≤10 mol. %.

In an alternative embodiment, the substrate 110 may comprise an alkali aluminosilicate glass composition comprising: 2 mol. % or more of Al₂O₃ and/or ZrO₂, or 4 mol. % or more of Al₂O₃ and/or ZrO₂.

Where the substrate 110 includes a crystalline substrate, the substrate may include a single crystal, which may include Al₂O₃. Such single crystal substrates are referred to as sapphire. Other suitable materials for a crystalline substrate include polycrystalline alumina and/or spinel (MgAl₂O₄).

Optionally, the substrate 110 may be crystalline and include a glass-ceramic substrate, which may be strengthened or non-strengthened. Examples of suitable glass ceramics may include Li₂O—Al₂O₃—SiO₂ system (i.e., LAS-System) glass ceramics, MgO—Al₂O₃—SiO₂ system (i.e., MAS-System) glass ceramics, and/or glass ceramics that include a predominant crystal phase including β-quartz solid solution, β-spodumene ss, cordierite, and lithium disilicate. The glass-ceramic substrates may be strengthened using the chemical strengthening processes disclosed herein. In one or more embodiments, MAS-System glass-ceramic substrates may be strengthened in Li₂SO₄ molten salt, whereby an exchange of 2Li⁺ for Mg²⁺ can occur.

The substrate 110 according to one or more embodiments can have a physical thickness ranging from about 50 μm to about 5 mm in various portions of the substrate 110. Example substrate 110 physical thicknesses range from about 50 μm to about 500 μm (e.g., 50, 75, 100, 200, 300, 400 or 500 μm). Further example substrate 110 physical thicknesses range from about 50 μm to about 2000 μm (e.g., 50, 75, 100, 250, 500, 600, 700, 800, 900, 1000, 1250, 1500, 1750, or 2000 μm). The substrate 110 may have a physical thickness greater than about 1 mm (e.g., about 2, 3, 4, or 5 mm). In one or more specific embodiments, the substrate 110 may have a physical thickness of 2 mm or less, or less than 1 mm. The substrate 110 may be acid polished or otherwise treated to remove or reduce the effect of surface flaws.

The cover articles 100, as depicted in exemplary form in FIGS. 1A-1D and disclosed herein, may be incorporated into another article such as an article with a display (or display articles) (e.g., consumer electronics, including mobile phones, tablets, computers, navigation systems, and the like), architectural articles, transportation articles (e.g., automotive, trains, aircraft, sea craft, etc.), appliance articles, or any article that requires some semitransparency, antireflective properties and/or touchscreen capability.

### EXAMPLES

Various embodiments of the disclosure (e.g., any of the cover articles 100 depicted in FIGS. 1A-1D) will be further clarified by the following examples. As specifically noted, the optical properties (e.g., reflectance and transmittance) of the examples were measured using the stated method and apparatus or otherwise modeled using computational techniques, particularly transfer matrix modeling techniques to model thin film performance as understood by those of skill in the field of this disclosure. Thin film properties (e.g., refractive index values) obtained from prior thin film reactive sputtering of films (e.g., high RI layers of SiNₓ), lab experiments, and higher volume sputter manufacturing, were used in the modeling.

The refractive indices and extinction coefficient (as a function of wavelength) of the layers and the substrates of the modeled cover article examples were measured using spectroscopic ellipsometry in prior experiments. In some examples focusing on layer properties, these as-measured properties are reported. The refractive indices thus measured were then used to calculate reflectance spectra for the examples. The examples use a single refractive index value in their descriptive tables for convenience, which corresponds to a point selected from the dispersion curves at about 550 nm wavelength, about the midpoint of the visible spectrum.

### Example 1

In this example, thin chromium (Cr) films were sputtered at room temperature onto Corning® Eagle XG® substrates. Electrical sheet resistance was measured by 4-point probe (CD ResMap) and optical properties were determined by collecting R, T, and A spectra with a Filmetrics F50xy, and thickness and optical constants were determined by spectroscopic ellipsometry (Woollam M-2000).

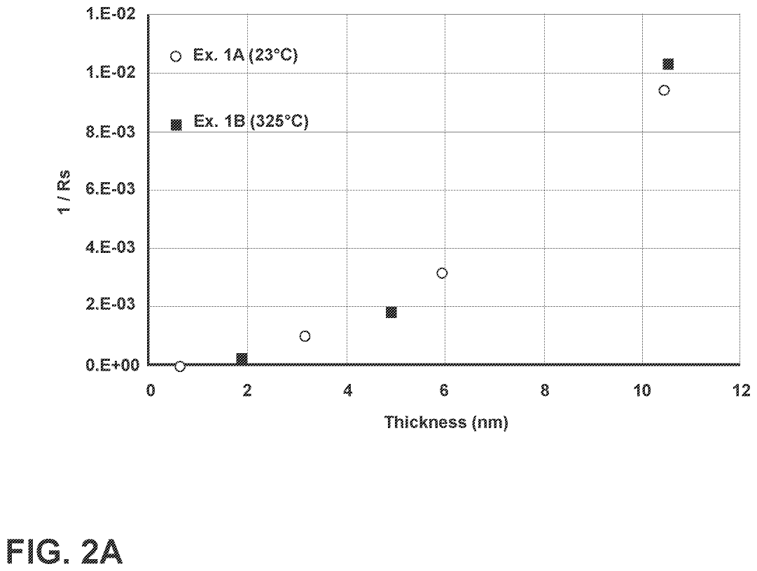

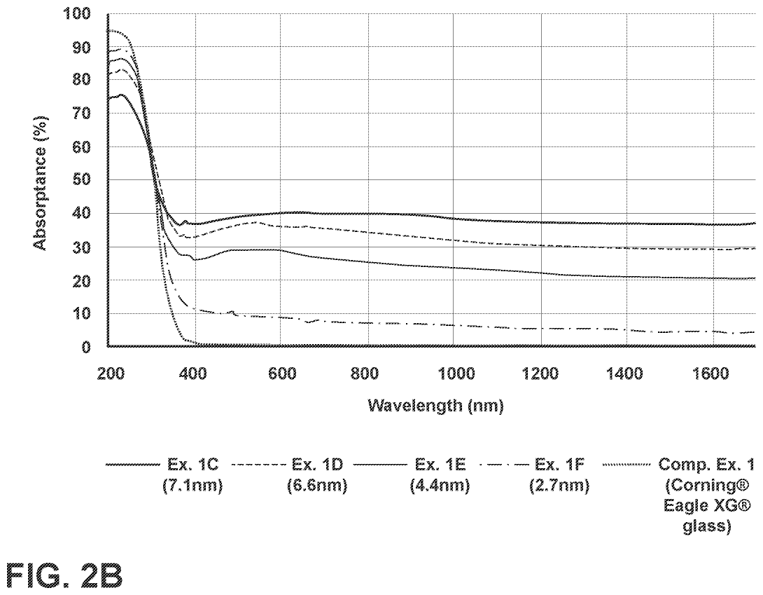

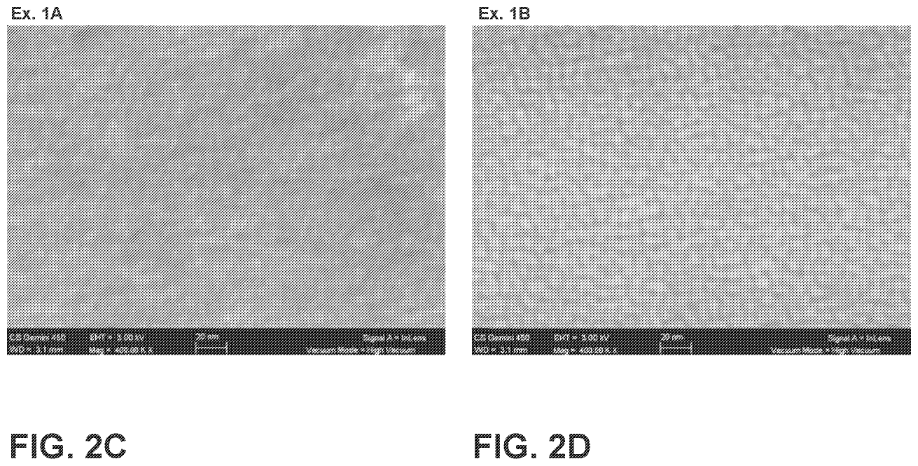

Referring to FIG. 2A, a plot is provided of the inverse of sheet resistance vs. film thickness for chromium films of various thicknesses deposited at 23° C. and 325° C., Exs. 1A and 1B, respectively. Referring to FIG. 2B, a plot is provided of absorptance vs. wavelength for the glass substrate (Comp. Ex. 1) and chromium films of various thicknesses of 7.1 nm, 6.6 nm, 4.4 nm, and 2.7 nm deposited on the glass substrate at 23° C., Exs. 1C-1F, respectively. As is evident from FIG. 2A, below ~3 nm, the inverse of the sheet resistance of the chromium layer is seen to deviate from a linear slope. Similarly the infrared absorption is seen in FIG. 2B to anomalously decrease below the same thickness range suggesting the percolation threshold to be in this thickness range.

Referring now to FIGS. 2C and 2D, scanning electron microscopy (SEM) images are provided of a chromium film having a thickness of 1.8 nm deposited at 23° C. (Ex. 1A) and a thickness of 1.3 nm deposited at 325° C. (Ex. 1B), respectively. The ‘island’ or ‘island-like’ structure of the chromium films is clearly visible. That is, the chromium films are physically discontinuous, and electrons have some difficulty in transferring from one ‘island’ to another which reduces their electrical conductance. These results suggest thin chromium layers below ~2 nm thickness should be suitable absorber layers with low electrical conductance that do not exceed the percolation threshold for chromium.

### Example 2

In this example, thin nickel (Ni) films were sputtered at room temperature onto 1 mm thick Corning® Gorilla® Glass 3 substrates (i.e., a chemically strengthened glass substrate). Electrical sheet resistance was measured by 4-point probe (CD ResMap) and optical properties were determined by collecting R, T, and A spectra with a Filmetrics F50xy, and thickness and optical constants were determined by spectroscopic ellipsometry (Woollam M-2000).

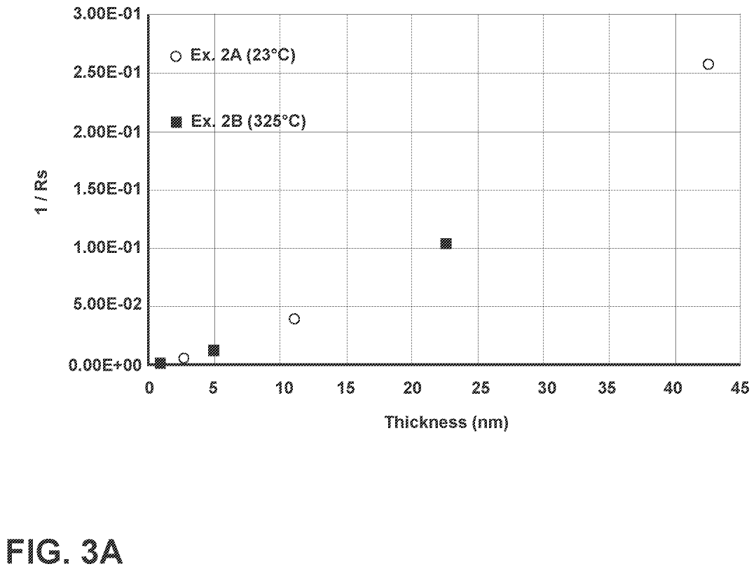

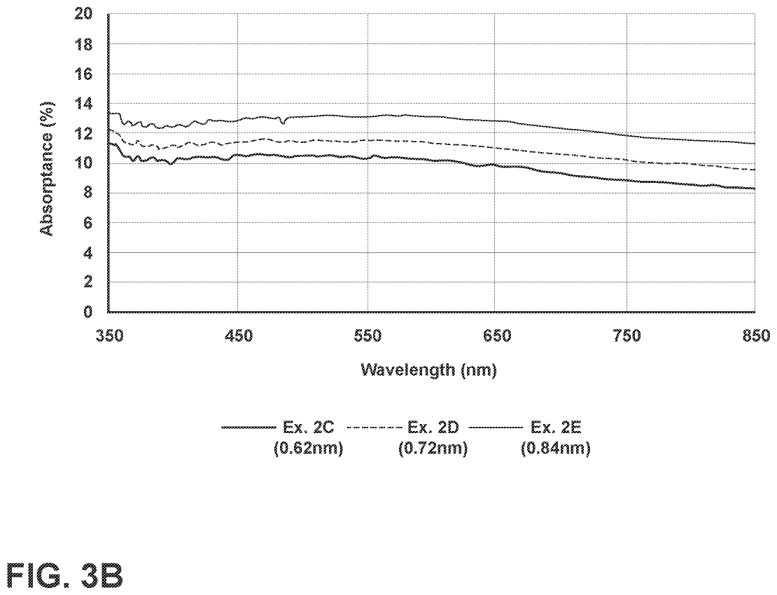

Referring to FIG. 3A, a plot is provided of the inverse of sheet resistance vs. film thickness for nickel films of various thicknesses deposited at 23° C. and 325° C. from 0.88 nm to 42 nm, Exs. 2A and 2B, respectively. Referring to FIG. 3B, a plot is provided of absorptance vs. wavelength for nickel films of various thicknesses of 0.62 nm, 0.72 nm, and 0.84 nm deposited on the glass substrate at 23° C., Exs. 2C, 2D and 2E, respectively. As is evident from FIGS. 3A and 3B, below ~0.88 nm, the sheet resistance is not measurable (<500 kOhm/sq), yet these layers produce more than 10% optical absorptance across the visible spectrum.

### Example 3

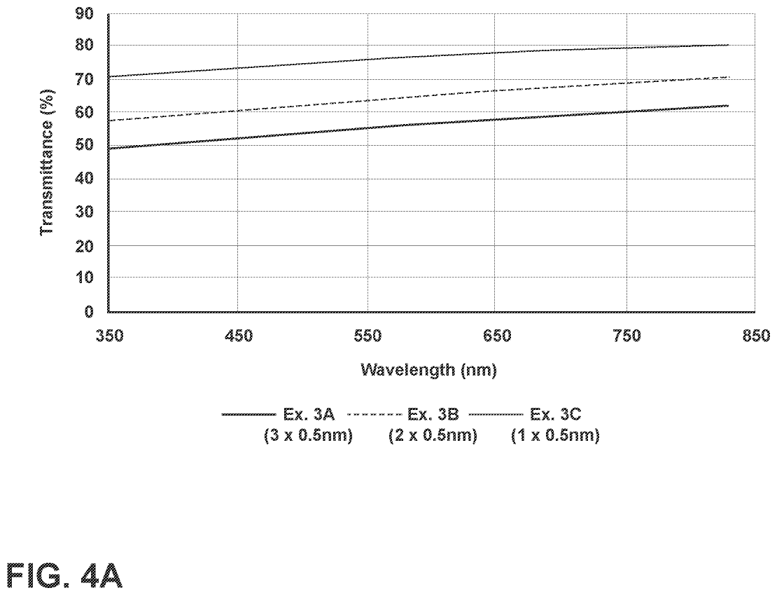

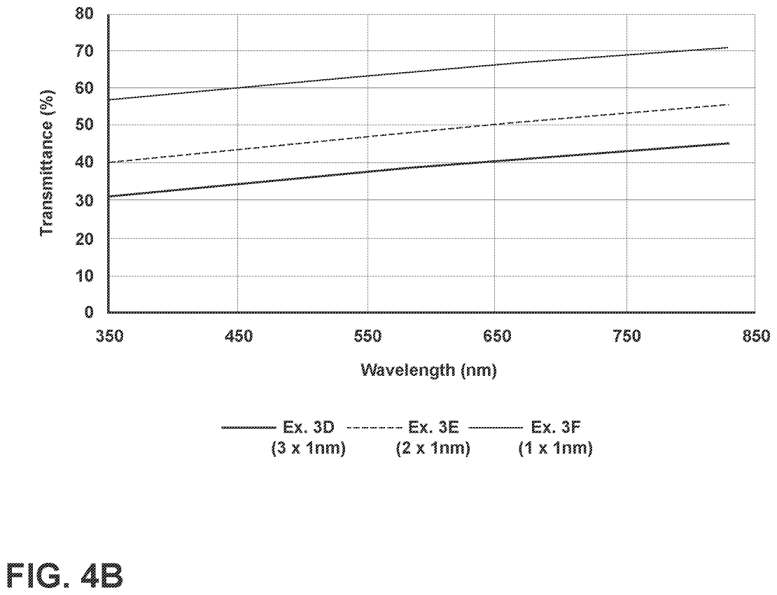

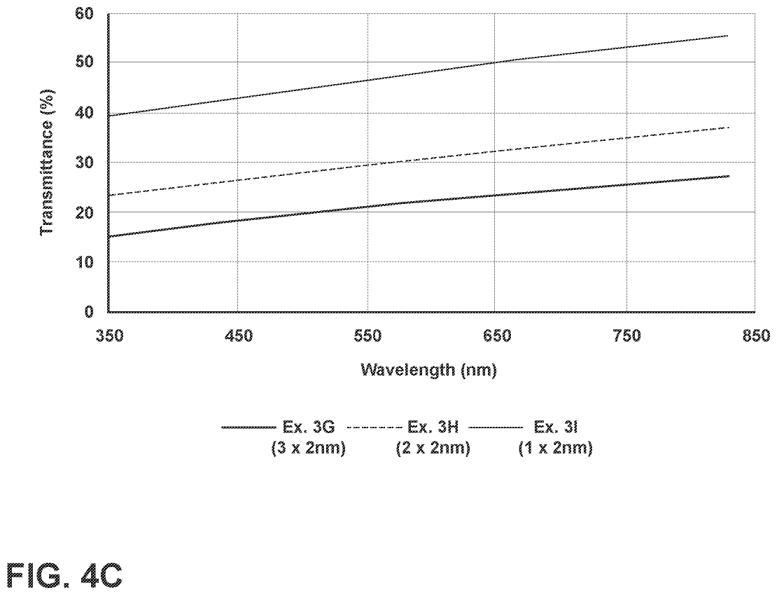

Using the optical data from Example 1, transmittance values are modeled for these chromium films. In particular, the transmittance levels of absorber stacks containing one to three Cr layers of 0.5, 1 and 2 nm thickness were simulated in this example. Referring to FIGS. 4A-4C, plots of transmittance vs. wavelength are provided for one, two and three layers of chromium at the three thickness levels (i.e., 0.5, 1 and 2 nm), Exs. 3A-3I, respectively, with thin layers of silica deposited between each chromium layer. As is evident from FIGS. 4A-4C, these results indicate that the cover article configurations of the disclosure can be tuned for average transmittance levels from 20% to 80% (over a wavelength range of 350 nm to 850 nm), including levels driven by particular end-use display applications. This tuning can be effected through variance of the composition, thickness and number of absorber layers.

### Example 4

Table 1 shows a design (Ex. 4) for a cover article of the disclosure (see also FIG. 1A) with semitransparency and antireflective (AR) properties. In particular, the outer layered film (AR stack) employs five alternating layers of low and high refractive index material, SiO₂ and SiNₓ. Further, the inner layered film (absorber stack) employs 0.16 nm thick chromium absorber layers with 10 nm SiO₂ dielectric spacers (low RI layers).

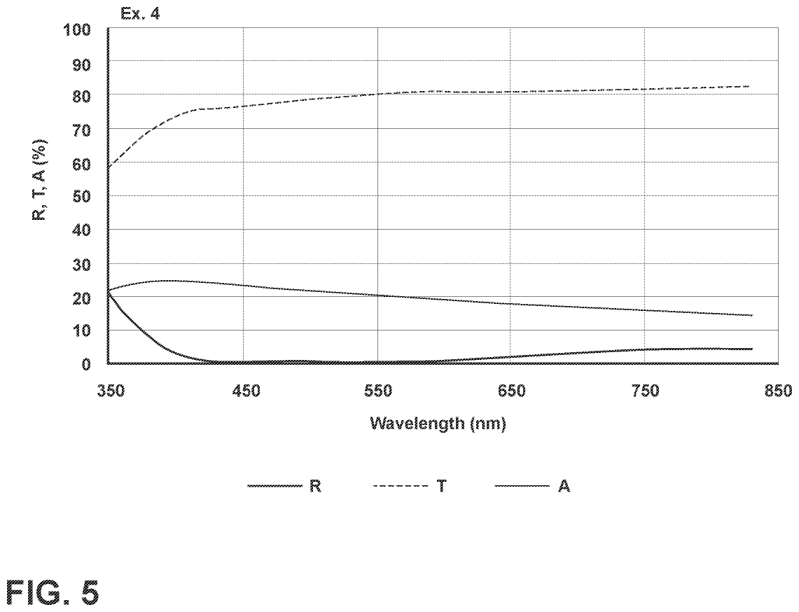

Referring to FIG. 5, a plot is provided of the reflectance, transmittance and absorptance v. wavelength for the Ex. 4 cover article. As is evident from FIG. 5, this design exhibits an average transmittance of about 80% and an average reflectance of about 0.6% across the visible spectrum from 400 to 700 nm. In addition, the cover article design of Ex. 4, with a Corning® Gorilla® Glass 3 substrate, was placed on an Apple® iPad® and no change was observed in the touchscreen performance of the iPad® device.

TABLE 1
Ex. 4, Cover Article for Deadfront Display

| | Layered film | | Layer thickness |
|---|---|---|---|
| Layer | stack | Material | (nm) |
| Substrate | N/A | Glass - Corning ® | 1 mm |
| | | Gorilla ® Glass 3 | |
| 1 | Inner layered film | SiO₂ | 10 |
| 2 | (absorber stack) | Cr | 0.16 |
| 3 | | SiO₂ | 10 |
| 4 | | Cr | 0.16 |
| 5 | | SiO₂ | 10 |
| 6 | | Cr | 0.16 |
| 7 | | SiO₂ | 10 |
| 8 | | Cr | 0.16 |
| 9 | | SiO₂ | 10 |
| 10 | | Cr | 0.16 |
| 11 | Outer layered film | SiO₂ | 10 |
| 12 | (AR stack) | SiNₓ | 49.81 |
| 13 | | SiO₂ | 19.06 |
| 14 | | SiNₓ | 73.25 |
| 15 | | SiO₂ | 91.57 |
| Air | N/A | N/A | N/A |

### Example 5

Table 2 shows a design (Ex. 5) for a cover article of the disclosure (see also FIG. 1A) with semitransparency and antireflective (AR) properties. In particular, the outer layered film (AR stack) employs five alternating layers of low and high refractive index material, SiO₂ and SiNₓ. Further, the inner layered film (absorber stack) employs 0.6 nm thick nickel absorber layers with 10 nm SiO₂ dielectric spacers (low RI layers).

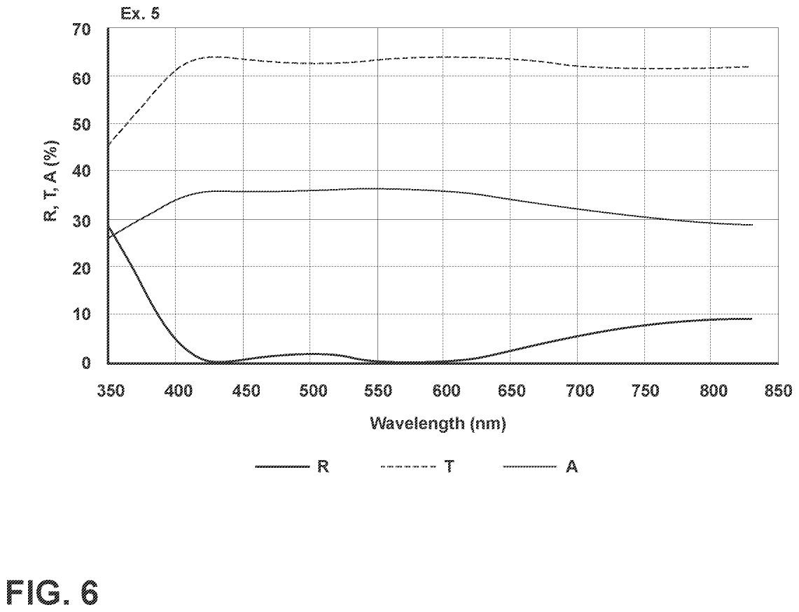

Referring to FIG. 6, a plot is provided of the reflectance, transmittance and absorptance v. wavelength for the Ex. 5 cover article. As is evident from FIG. 6, this design exhibits an average transmittance of about 63% and an average reflectance of about 0.8% reflectance across the visible spectrum from 400 to 700 nm.

TABLE 2
Ex. 5, Cover Article for Deadfront Display

| | Layered film | | Layer thickness |
|---|---|---|---|
| Layer | stack | Material | (nm) |
| Substrate | N/A | Glass - Corning ® | 1 mm |
| | | Gorilla ® Glass 3 | |
| 1 | Inner layered film | SiO₂ | 10 |
| 2 | (absorber stack) | Ni | 0.6 |
| 3 | | SiO₂ | 10 |
| 4 | | Ni | 0.6 |
| 5 | | SiO₂ | 10 |
| 6 | | Ni | 0.6 |
| 7 | | SiO₂ | 10 |
| 8 | | Ni | 0.6 |
| 9 | | SiO₂ | 10 |
| 10 | | Ni | 0.6 |
| 11 | Outer layered film | SiO₂ | 10 |
| 12 | (AR stack) | SiNₓ | 51.67 |
| 13 | | SiO₂ | 25.38 |
| 14 | | SiNₓ | 73.59 |
| 15 | | SiO₂ | 90.12 |
| Air | N/A | N/A | N/A |

### Example 6

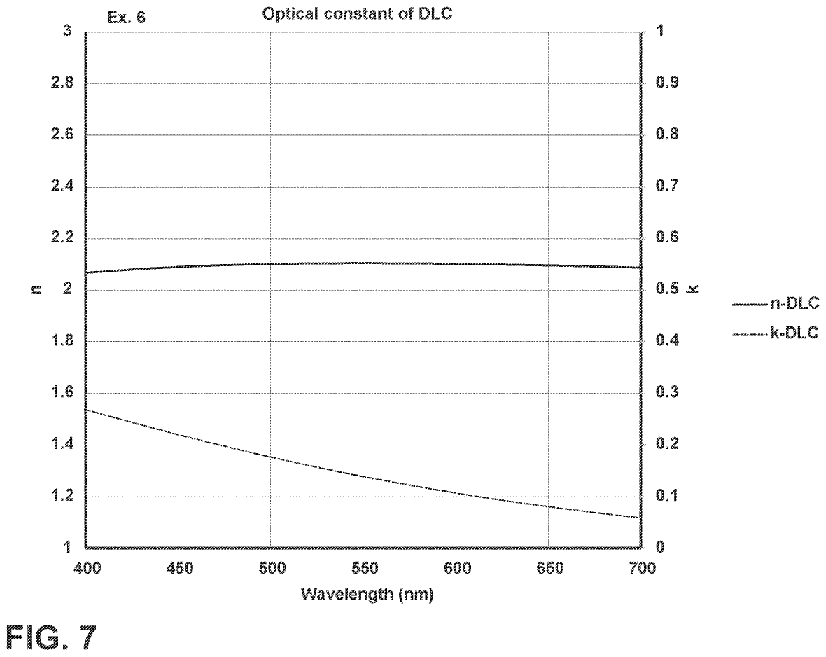

In this example, thin diamond-like carbon (DLC) films were deposited at room temperature by PECVD onto 1 mm Corning® Gorilla® Glass 3 substrates. The films of this example (Ex. 6) were deposited using a PECVD process and measured for refractive index and extinction coefficient across the visible spectrum using spectroscopic ellipsometry. Referring to FIG. 7, a plot is provided of refractive index and extinction coefficient (n, k) of the diamond-like carbon (DLC) layer. As is evident from FIG. 7, the DLC layer exhibits a refractive index (n) between 2.0 to 2.2 and a maximum extinction coefficient of about 0.27 across the visible spectrum from 400 nm to 700 nm. In addition, these values suggest that the absorption of the DLC layers is higher than the absorption of other dielectric materials, such as SiO₂ and Nb2O₅, making DLC layers particularly advantageous for use in the cover articles of the disclosure.

### Example 7A

Table 3A shows a design (Ex. 7A) for a cover article of the disclosure (see also FIG. 1B) with semitransparency and antireflective (AR) properties, as configured with one DLC absorber layer. In particular, the outer layered film (AR stack) employs seven alternating layers of low and high refractive index material, SiO₂ and Nb₂O₅. Further, the inner layered film (absorber stack) employs a single DLC absorber layer having a thickness of 50 nm.

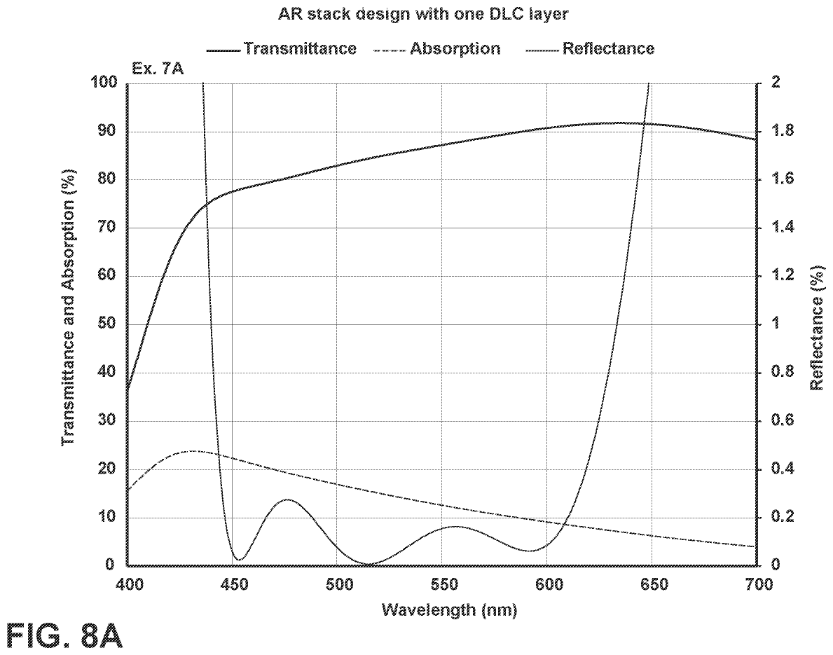

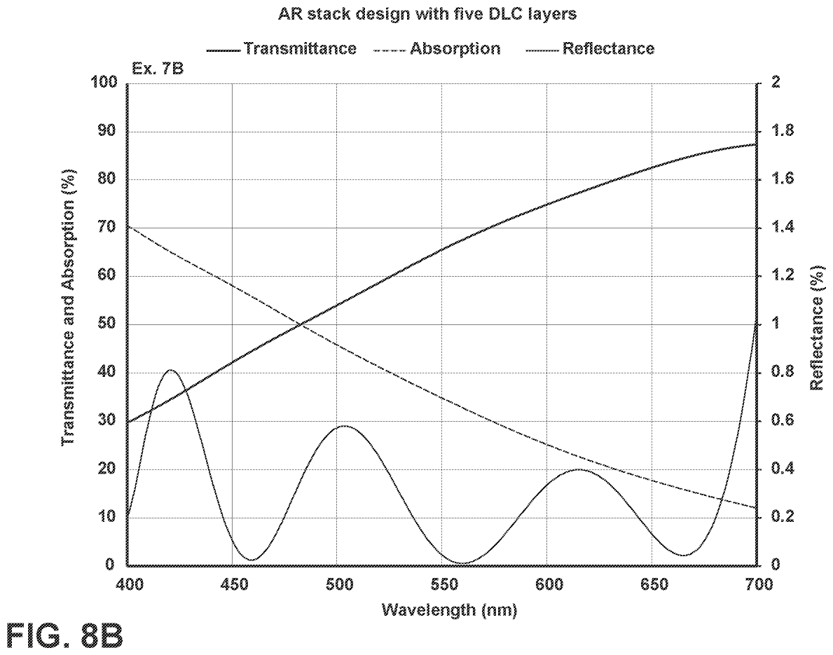

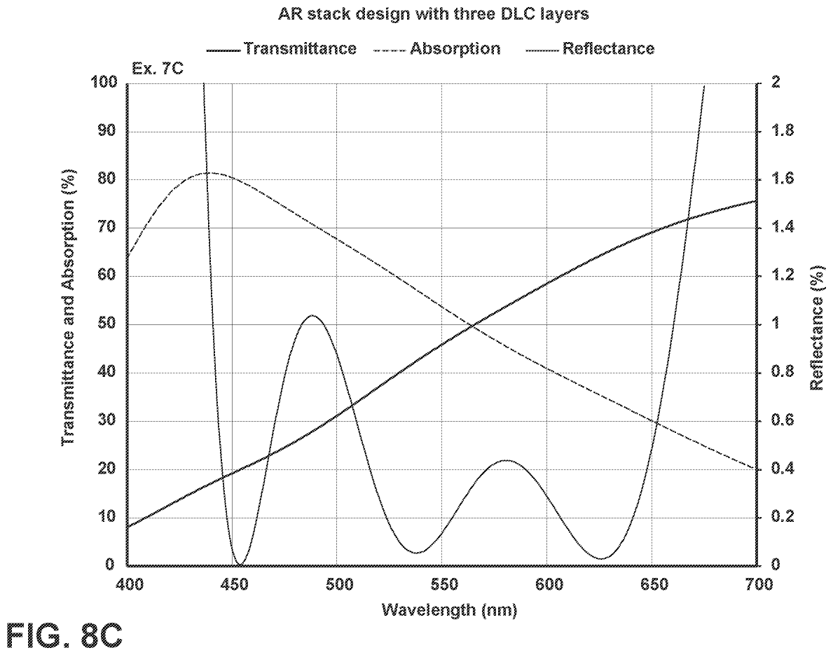

Referring to FIG. 8A, a plot is provided of the reflectance, transmittance and absorption v. wavelength for the Ex. 7A cover article. As is evident from FIG. 8A, this design exhibits an average transmittance of about 83.2% and an average absorption of about 13.1% across the visible spectrum from 400 to 700 nm, and an average photopic reflectance of about 0.28%.

TABLE 3A
Ex. 7A, Cover Article for Deadfront Display

| | Layered film | | Layer thickness |
|---|---|---|---|
| Layer | stack | Material | (nm) |
| Substrate | N/A | Glass - Corning ® | 1 mm |
| | | Gorilla ® Glass 3 | |
| 1 | Inner layered film | DLC | 50 |
| | (absorber stack) | | |
| 2 | Outer layered film | SiO₂ | 10 |
| 3 | (AR stack) | Nb₂O₅ | 51.3 |
| 4 | | SiO₂ | 49.4 |
| 5 | | Nb₂O₅ | 28.3 |
| 6 | | SiO₂ | 50 |
| 7 | | Nb₂O₅ | 35.8 |
| 8 | | SiO₂ | 106.4 |
| Air | N/A | N/A | N/A |

### Example 7B

Table 3B shows a design (Ex. 7B) for a cover article of the disclosure (see also FIG. 1C) with semitransparency and antireflective (AR) properties, as configured with five (5) DLC absorber layers in total. In particular, the outer layered film (AR stack) employs nine alternating layers of low refractive index (SiO₂) or high refractive index layers (Nb₂O₅), and absorber layers (DLC). Further, the inner layered film (absorber stack) employs a single DLC absorber layer having a thickness of 127.2 nm.

Referring to FIG. 8B, a plot is provided of the reflectance, transmittance and absorption v. wavelength for the Ex. 7B cover article. As is evident from FIG. 8B, this design exhibits an average transmittance of about 62.8% and an average absorption of about 36.8% across the visible spectrum from 400 to 700 nm, and an average photopic reflectance of about 0.25%.

TABLE 3B
Ex. 7B, Cover Article for Deadfront Display

| | Layered film | | Layer thickness |
|---|---|---|---|
| Layer | stack | Material | (nm) |
| Substrate | N/A | Glass - Corning ® | 1 mm |
| | | Gorilla ® Glass 3 | |
| 1 | Inner layered film | DLC | 127.2 |
| | (absorber stack) | | |
| 2 | Outer layered film | SiO₂ | 77.2 |
| 3 | (AR stack) | DLC | 7.5 |
| 4 | | SiO₂ | 62.7 |
| 5 | | DLC | 10.5 |
| 6 | | Nb₂O₅ | 25.2 |
| 7 | | DLC | 18.2 |
| 8 | | Nb₂O₅ | 43.6 |
| 9 | | DLC | 7.3 |
| 10 | | SiO₂ | 83.3 |
| Air | N/A | N/A | N/A |

### Example 7C

Table 3C shows a design (Ex. 7C) for a cover article of the disclosure (see also FIG. 1B) with semitransparency and antireflective (AR) properties, as configured with three (3) DLC absorber layers in total. In particular, the outer layered film (AR stack) employs seven alternating layers of low refractive index (SiO₂), and high refractive index layers (Nb₂O₅) or absorber layers (DLC). Further, the inner layered film (absorber stack) employs a single DLC absorber layer having a thickness of 200 nm.

Referring to FIG. 8C, a plot is provided of the reflectance, transmittance and absorption v. wavelength for the Ex. 7C cover article. As is evident from FIG. 8C, this design exhibits an average transmittance of about 42.3% and an average absorption of about 53.5% across the visible spectrum from 400 to 700 nm, and an average photopic reflectance of about 0.44%.

TABLE 3C
Ex. 7C, Cover Article for Deadfront Display

| | Layered film | | Layer thickness |
|---|---|---|---|
| Layer | stack | Material | (nm) |
| Substrate | N/A | Glass - Corning ® | 1 mm |
| | | Gorilla ® Glass 3 | |
| 1 | Inner layered film | DLC | 200 |
| | (absorber stack) | | |
| 2 | Outer layered film | SiO₂ | 13.8 |
| 3 | (AR stack) | DLC | 60 |
| 4 | | SiO₂ | 42 |
| 5 | | DLC | 60 |
| 6 | | SiO₂ | 21.7 |
| 7 | | Nb₂O₅ | 40.6 |
| 8 | | SiO₂ | 102.2 |
| Air | N/A | N/A | N/A |

### Example 8

In this example, cover articles of the disclosure with semitransparency and antireflective (AR) properties were fabricated, as configured with one DLC absorber layer according to the design of Table 3A and with varying levels of thickness. In particular, DLC absorber layers having a thickness of 55 nm, 81 nm and 180 nm were employed in the samples of this example, designated Exs. 8A-8C, respectively.

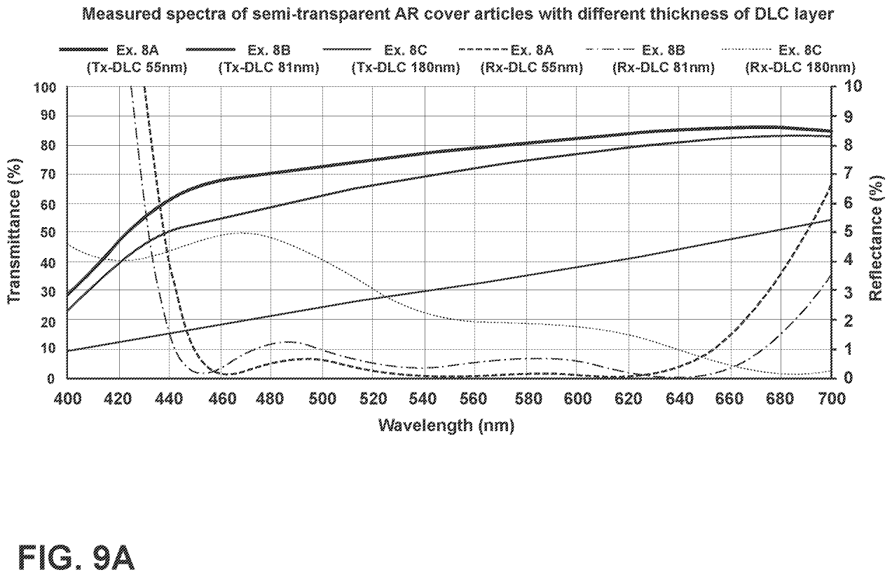

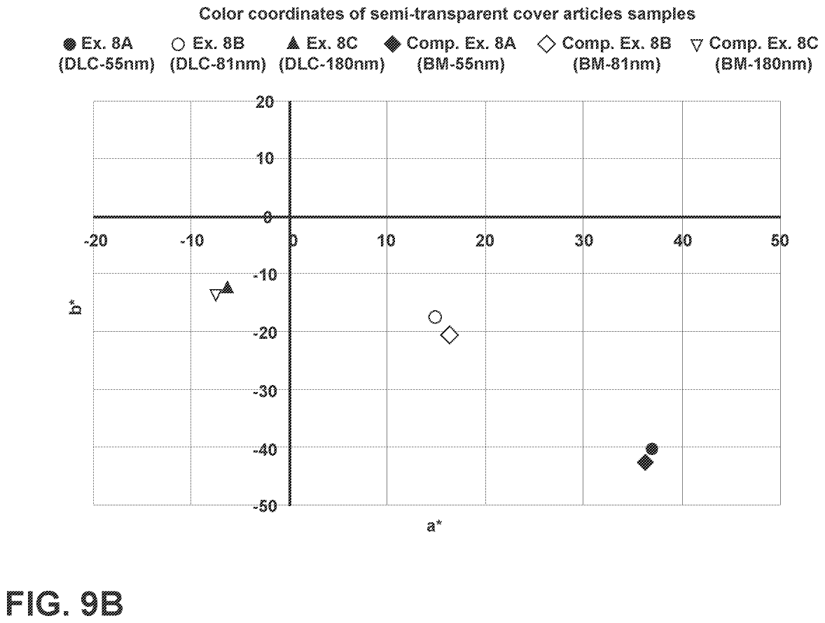

Referring to FIG. 9A, a plot is provided of reflectance and transmittance v. wavelength for the cover articles of this example (Exs. 8A-8C). The measured spectra demonstrate that the average transmittance (T) of these samples in the visible spectrum from 400 nm to 700 nm ranges from 30% to 75%, as a function of DLC layer thickness from 55 nm to 180 nm. Further, the reflectance (R) levels of these samples varies from 0.34% to 2.2%, as a function of DLC layer thickness from 55 nm to 180 nm. More specifically, the average transmittance and photopic reflectance values for the sample with a 55 nm DLC layer (Ex. 8A) is 74.1% and 0.34%, respectively; the average transmittance and photopic reflectance values for the sample with a 81 nm DLC layer (Ex. 8B) is 67.2% and 0.58%, respectively; and the average transmittance and photopic reflectance values for the sample with a 180 nm DLC layer (Ex. 8C) is 31.5% and 2.5%, respectively.

Referring now to FIG. 9B, a plot is provided of first-surface reflected color with a D65 illuminant at a normal incident measuring angle for the exemplary cover articles of this example (Exs. 8A-8C) and comparative cover articles with black matrix material (Comp. Exs. 8A-8C) of the same thickness as to the corresponding inventive cover article (i.e., 55 nm, 81 nm and 180 nm). The CIE L*,a*, and b* values for each of the samples of this example are: 3.1, 35.7, and −40.4 (Ex. 8A), respectively; 5.3, 16.4, and −24.8, respectively (Ex. 8B); and 17.8, −4.5, and −12.9, respectively (Ex. 8C). Notably, the reflected color coordinates of the samples of this example (Exs. 8A-8C) are very similar to the reflected color coordinates of the comparative, black matrix samples of this example (Comp. Exs. 8A-8C). This demonstrates that the cover articles of this example employing various DLC layer thickness levels can achieve comparable color levels as conventional black matrix coatings.

### Example 9

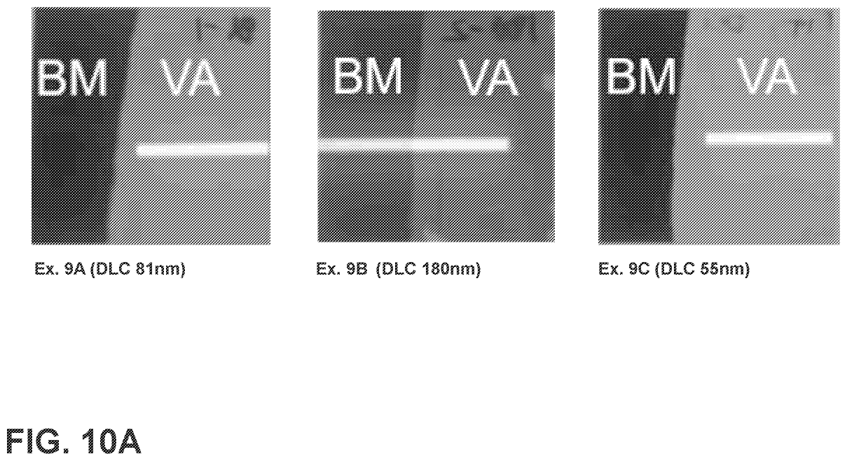

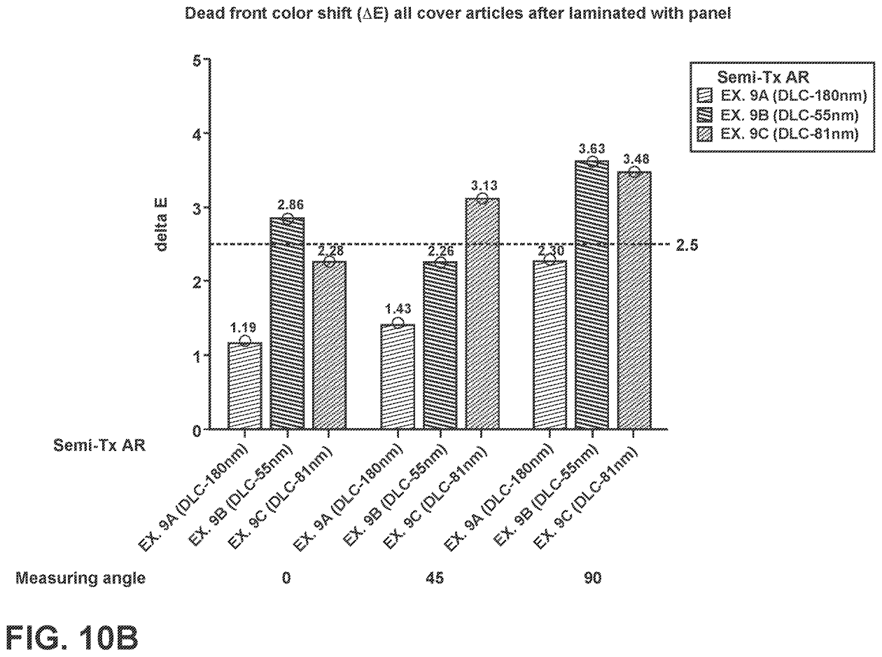

In this example, cover articles of Example 8 and the comparative articles of Example 8 are fabricated on respective portions of a glass substrate, as shown in FIG. 10A. As shown in the optical images of FIG. 10A, these samples are designated Exs. 9A-9C, each with a single DLC absorber layer having a thickness of 81 nm, 180 nm and 55 nm and a corresponding portion with black matrix material having the same thickness.

Deadfront color shift values (ΔE) were then calculated for each of the samples (Exs. 9A-9C), at incident measuring angles of 0°, 450 and 90°, using a* and b* color coordinate measurements made on the samples by a CM-700d (Konica-Minolta) spectrophotometer. Referring now to FIG. 10B, a bar graph is provided of the deadfront color shift (ΔE) values calculated for each of these cover articles. The data in FIG. 10B clearly shows that the semitransparent cover articles with AR properties having a DLC absorber layer thickness of 180 nm presents a very good deadfront effect over all incident measuring angles, and ΔE is 2.3 at 90° and less than 1.5 both for 0° and 45°. In comparison, the ΔE value between a conventional black matrix and a viewing area of an LCD module (uncovered by the conventional black matrix) is >5 at a 45° incident measuring angle. These results indicate that the layered films described herein improve deadfronting performance over existing displays.

### Example 10

In this example, Examples 11 and 12, and Comparative Examples 13 and 14, thin metal alloy absorber layer films (<150 nm thickness) were co-sputtered both on Si and 1 mm thick Corning® Gorilla® Glass 3 substrates (i.e., a chemically strengthened glass substrate) in a confocal geometry by DC sputtering in an AJA Orion sputtering deposition system at room temperature. Sputtering was conducted using 3″ targets in an argon atmosphere at 2 mTorr. All composition determinations were made by measuring the deposition rate of each gun independently with a quartz crystal monitor. The resulting films were characterized by a four point probe (CD ResMap), optical transmittance and reflectance (Filmetrics F50xy) and spectroscopic ellipsometry for refractive index determinations (Woollam CompleteEase). Touchscreen compatibility assessments were made by placing each coated sample over an iPhone® SE and noting the impact of the sample on touchscreen performance using the calculator application of the iPhone®.

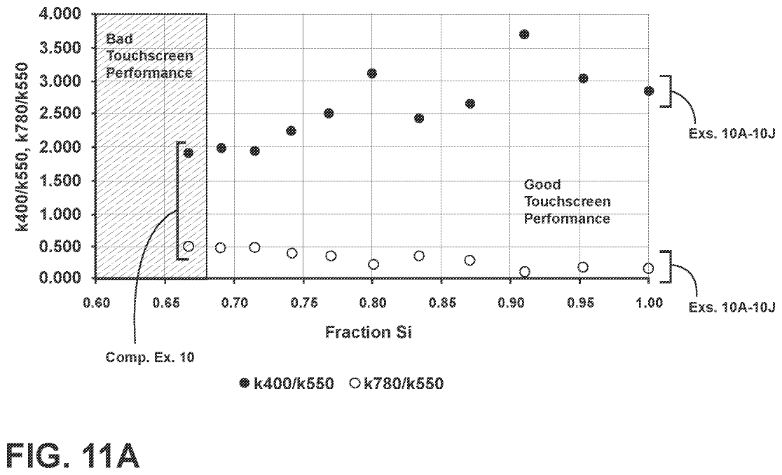

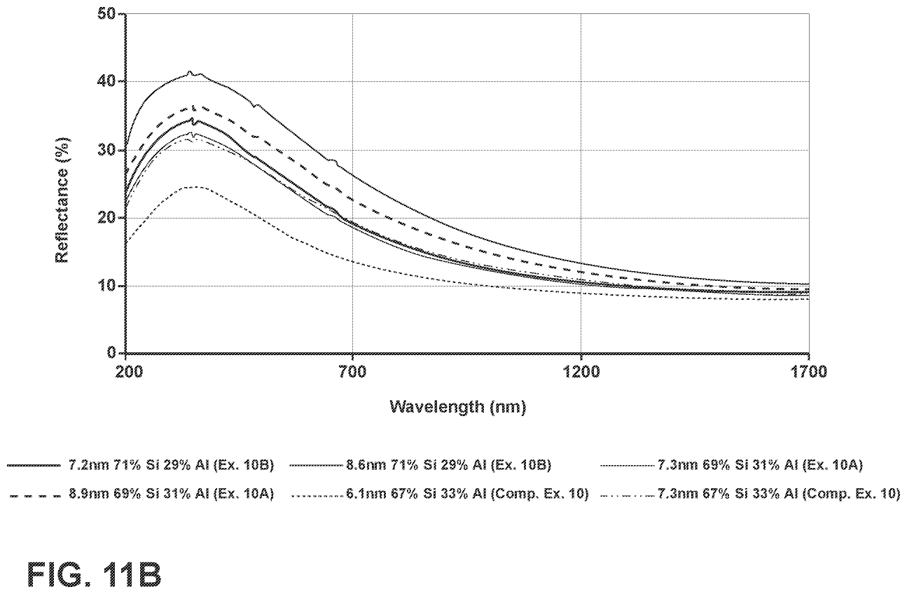

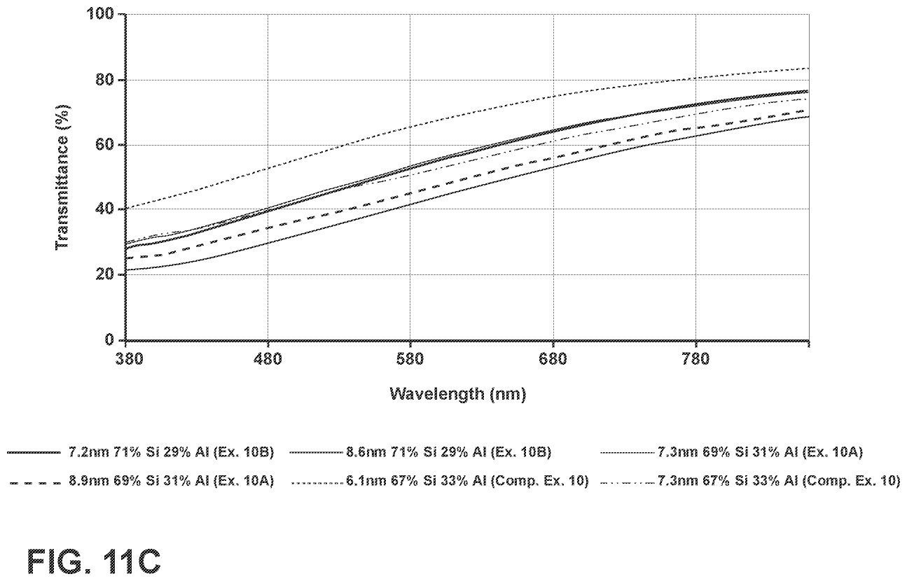

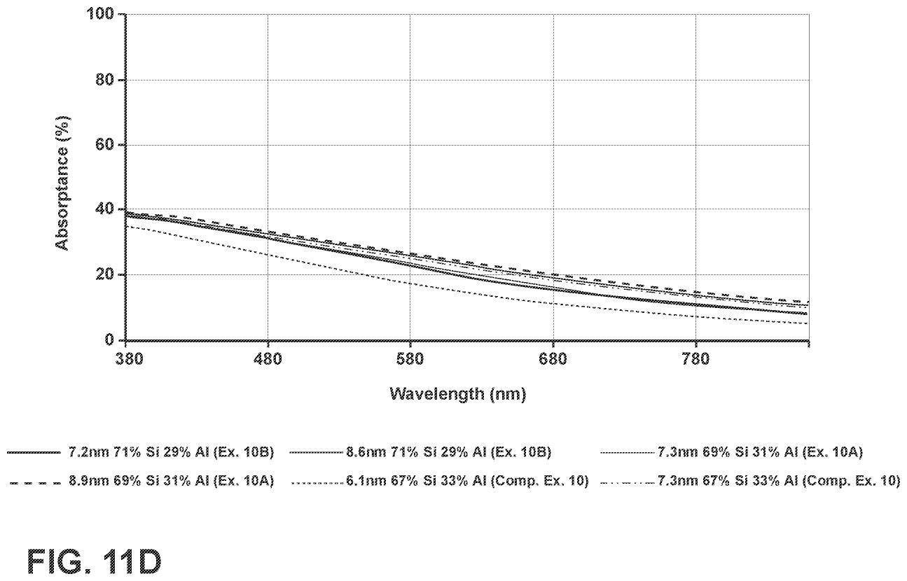

In this example, thin absorber films of Si—Al alloys were deposited with various compositions, as noted below in Table 4 and shown in FIG. 11A. Table 4 also lists the inverse of sheet resistance (“1/Rs”), optical density (“OD”), transmittance at 550 nm (“T 550 nm”), film thickness (“Th(nm)”), and touchscreen capability (“Touch”). Referring to FIG. 11A, a plot is provided of the ratio of extinction coefficient (k) at 400 nm to 550 nm and 780 nm to 440 nm for the Si—Al films of this example as a function of Si volume fraction. As evident from Table 4 and FIG. 11A, acceptable touchscreen performance was observed in films with greater than equal to 69% silicon (by volume) (i.e., Exs. 10A-10J) and a Si—Al alloy film with 67% Si demonstrated unacceptable touchscreen performance (i.e., Comp. Ex. 10).

Referring to FIGS. 11B-11D, respective plots are provided of reflectance, transmittance and absorptance vs. wavelength for three Si—Al film compositions (65-71% Si) of this example and a comparative example (i.e., Ex. 10A, Ex. 10B, and Comp. Ex. 10) at two film thicknesses. In particular, these figures show the optical performance of thin (<10 nm) thick Si—Al films according to this example. Transmission is higher in red than blue, but the performance is better than DLC absorber layers. From these measurements, it is seen that semitransparent AR coatings can be formed with Si—Al film thickness<50 nm for transmission as low as 10%. The relative red and blue absorption of the film is quantified by plotting k at 400 nm normalized to k at 550 nm, and k at 780 nm normalized to 550 nm. An ideal material would exhibit k400/k550=k780/k550=1. For Si—Al alloy absorber films, the best optical performance is achieved at near 70% Si (by volume) where k400/k550 is about 2 and k780/k550 is about 0.5.

TABLE 4
Properties of Si—Al alloy absorber
films as a function of Si volume fraction

| | % | | | T 550 nm | Th | |
|---|---|---|---|---|---|---|
| Example | Si | 1/Rs | OD | (%) | (nm) | Touch |
| Ex. 10J | 100 | 0.00E+00 | 0.9 | ** | 83.6 | Y |
| Ex. 10I | 95 | 0.00E+00 | 0.96 | 7.45 | 95.5 | Y |
| Ex. 10H | 91 | 0.00E+00 | 1.03 | 6.39 | 101.5 | Y |
| Ex. 10G | 87 | 0.00E+00 | 1.16 | 4.56 | 100.3 | Y |
| Ex. 10F | 83 | 0.00E+00 | 1.37 | 2.72 | 99.7 | Y |
| Ex. 10E | 80 | 0.00E+00 | 1.4 | 0.5 | 115.6 | Y |
| Ex. 10D | 77 | 0.00E+00 | 1.58 | 1.49 | 109.4 | Y |
| Ex. 10C | 74 | 0.00E+00 | 1.83 | 0.72 | 121.7 | Y |
| Ex. 10B | 71 | 0.00E+00 | 2.02 | 0.5 | 109.5 | Y |
| Ex. 10A | 69 | 8.82E−08 | 2.23 | 0.26 | 129.7 | Y |
| Comp. Ex. 10 | 67 | 3.15E−04 | 2.32 | 0.25 | 115.7 | N |
| N/A | 0 | 9.54E−01 | 3.13 | ** | 41.6 | N |

### Example 11

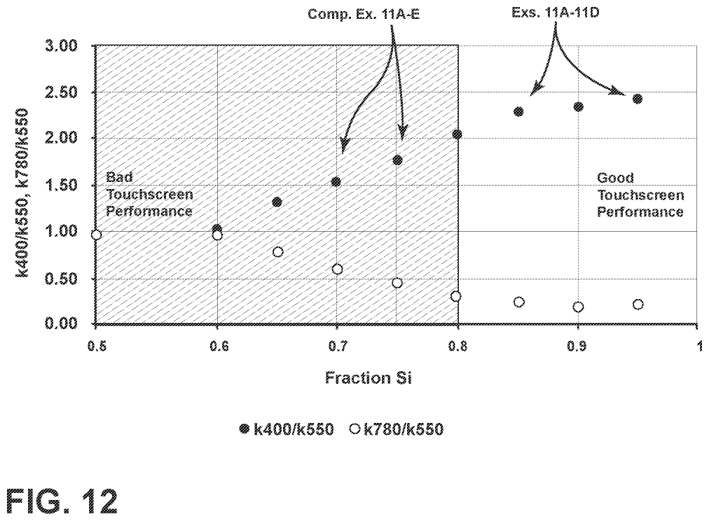

In this example, thin absorber films of Si—Zn alloys were deposited with various compositions, as shown in FIG. 12. Referring to FIG. 12, a plot is provided of the ratio of extinction coefficient (k) at 400 nm to 550 nm and 780 nm to 440 nm for the Si—Zn films of this example as a function of Si volume fraction, each with a thickness of 105.53 nm. As evident from FIG. 12, acceptable touchscreen performance was observed in films with greater than equal to 80% silicon (by volume) (i.e., Exs. 11A-11D) and Si—Zn alloy films with less than 80% Si (by volume) demonstrated unacceptable touchscreen performance (i.e., Comp. Exs. 11A-E). Further, the best optical performance is observed in the Si—Zn films with about 80% Si (by volume) (Ex. 11A) in which k400/k550 is 2 and k780/k550 is 0.31, as shown in FIG. 12.

### Example 12

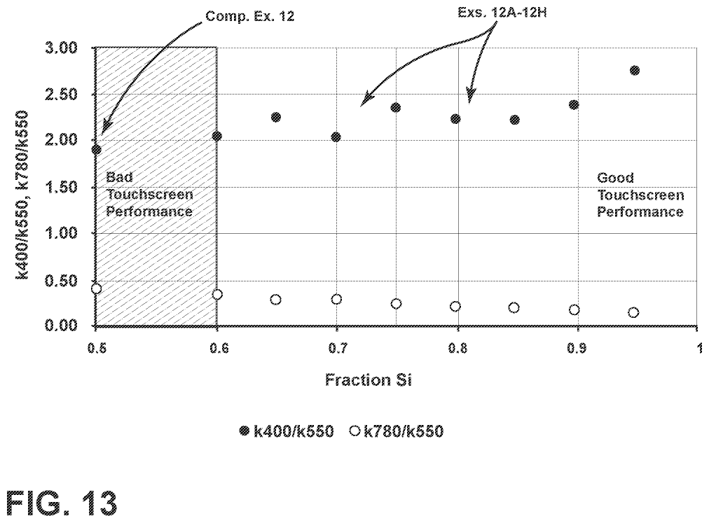

In this example, thin absorber films of Si—Sn alloys were deposited with various compositions, as shown in FIG. 13. Referring to FIG. 13, a plot is provided of the ratio of extinction coefficient (k) at 400 nm to 550 nm and 780 nm to 440 nm for the Si—Sn films of this example as a function of Si volume fraction, each with a thickness of 105.92 nm. As evident from FIG. 13, acceptable touchscreen performance was observed in films with greater than equal to 60% silicon (by volume) (i.e., Exs. 12A-12H) and Si—Sn alloy films with less than 60% Si (by volume) demonstrated unacceptable touchscreen performance (i.e., Comp. Ex. 12). Further, the best optical performance is observed in the Si—Zn films with about 60% Si (by volume) (Ex. 12A) in which k400/k550 is 2 and k780/k550 is 0.37, as shown in FIG. 13.

### Comparative Example 13

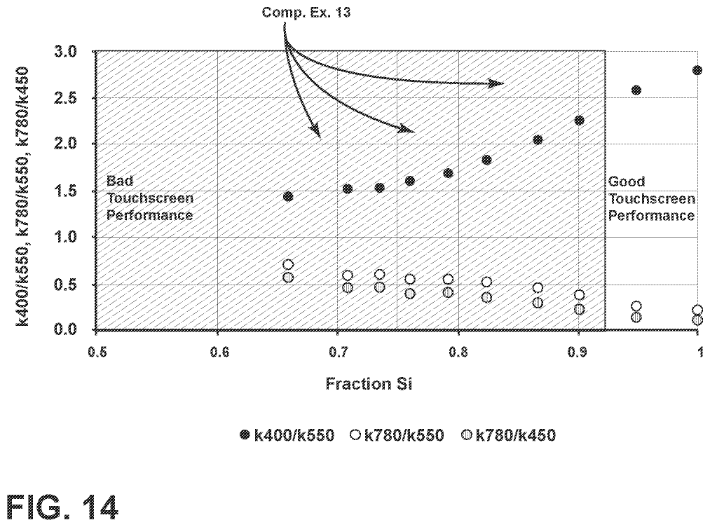

In this comparative example, thin absorber films of Si—Cu alloys were deposited with various compositions, as shown in FIG. 14 (all, designated “Comp. Ex. 13”). Referring to FIG. 14, a plot is provided of the ratio of extinction coefficient (k) at 400 nm to 550 nm and 780 nm to 440 nm for the Si—Cu films of this example as a function of Si volume fraction, each with a thickness of 51.50 nm. As evident from FIG. 14, only acceptable touchscreen performance was observed in films with greater than equal to 95% silicon (by volume). Nevertheless, all samples are deemed unacceptable as all of the Si—Cu alloys form silicides and the compositional range of acceptable touchscreen performance is narrow. Further, the Si—Cu films of this example exhibit k400/k550 of 2.0 and k780/k550 of 0.37, as depicted in FIG. 14.

### Comparative Example 14

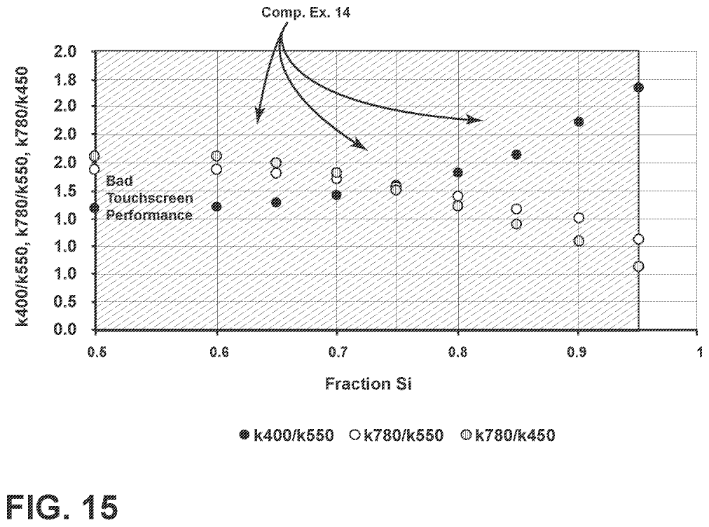

In this comparative example, thin absorber films of Si—Cr alloys were deposited with various compositions, as shown in FIG. 15 (all, designated “Comp. Ex. 14”). Referring to FIG. 15, a plot is provided of the ratio of extinction coefficient (k) at 400 nm to 550 nm and 780 nm to 440 nm for the Si—Cr films of this example as a function of Si volume fraction. As evident from FIG. 15, no acceptable touchscreen performance was observed in the films of this example, including films with greater than equal to 95% silicon (by volume). Further, all samples are deemed unacceptable as all of the Si—Cr alloys form silicides.

### Example 15

In this example, cover articles of the disclosure with semitransparency and antireflective (AR) properties were fabricated, as configured with one absorber layer comprising a Si—Al alloy comparable in composition and structure as Ex. 10A (see Table 4 in Example 10 above), according to the design of Table 5 below (designated “Ex. 15”). In particular, the Si—Al alloy absorber layer is located in the inner layered film above an alternating impedance matching stack of SiO₂, Nb₂O₅ and SiO₂ layers, and has a thickness of 9.64 nm. The impedance matching stack is intended to minimize reflection from the substrate, which is a Corning® Gorilla® Glass 3 substrate. Further, in this cover article design, the outer layered film has a plurality of Nb₂O₅ and SiO₂ layers configured to provide an antireflective (AR) function, with six layers in total.

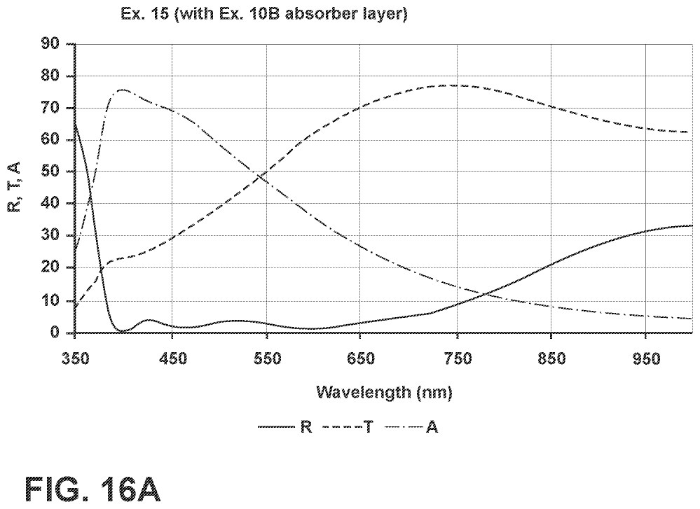

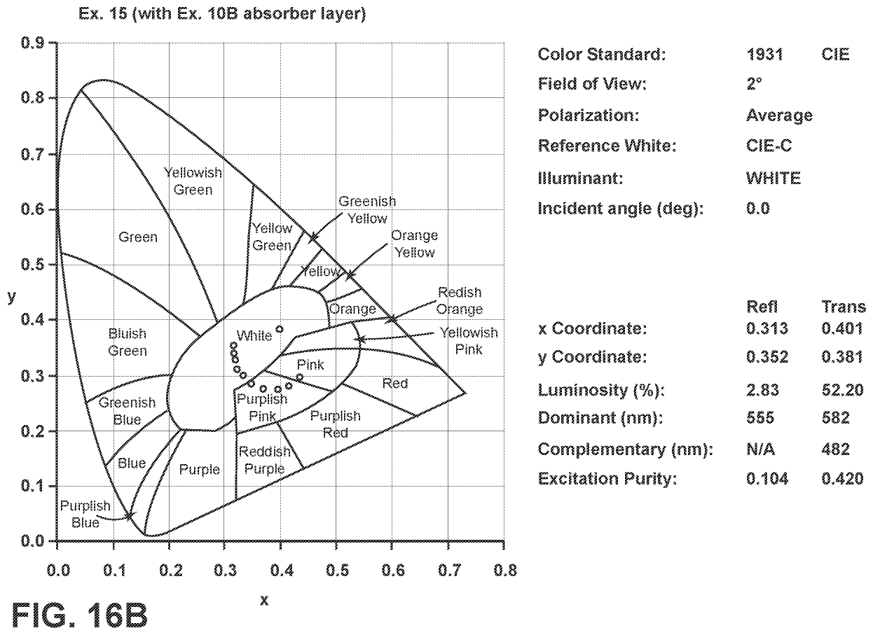

Referring to FIG. 16A, a plot is provided of simulated reflectance, transmittance and absorptance (%) v. wavelength for the exemplary cover article of this example (Ex. 15) employing a Si—Al absorber layer. As is evident from FIG. 16A, the samples of this example exhibit an average photoptic reflectance of 2.8% and an average transmittance of 53%.

Referring now to FIG. 16B, a simulated color plot of x and y coordinates in the 1931 CIE scale with a normal incident angle (0°) is provided for the cover article of this example (Ex. 15), which employs a Si—Al absorber layer. As is evident from FIG. 16B, the simulated color of this example is a white or pinkish hue.

TABLE 5
Ex. 15, Cover Article for Deadfront
Display with Si—Al absorber layer

| | Layered film | | Layer thickness |
|---|---|---|---|
| Layer | stack | Material | (nm) |
| Substrate | N/A | Glass - Corning ® | 1 mm |
| | | Gorilla ® Glass 3 | |
| 1 | Inner layered film | SiO₂ | 7.93 |
| 2 | (absorber stack) | Nb₂O₅ | 72.26 |
| 3 | | SiO₂ | 20.57 |
| 4 | | Si 0.69 / Al 0.31 | 9.64 |
| 5 | Outer layered film | Nb₂O₅ | 55.8 |
| 6 | (AR stack) | SiO₂ | 101.61 |
| 7 | | Nb₂O₅ | 7.42 |
| 8 | | SiO₂ | 60.67 |
| 9 | | Nb₂O₅ | 18.43 |
| 10 | | SiO₂ | 111.41 |
| Air | N/A | N/A | N/A |

The various features described in the specification may be combined in any and all combinations, for example, as listed in the following embodiments.

Embodiment 1. A cover article for a display panel is provided that includes: a substrate comprising a thickness from 50 μm to 5000 μm, an outer primary surface and an inner primary surface, wherein the outer and inner primary surfaces are opposite of one another and the substrate comprises a glass, glass-ceramic or ceramic material; an inner layered film disposed on the outer primary surface of the substrate; and an outer layered film disposed on the inner layered film. One or both of the inner layered film and the outer layered film comprises one more absorber layers. The outer layered film comprises a plurality of alternating high refractive index and low refractive index layers. Each of the high refractive index layers has a refractive index greater than a refractive index of each of the low refractive index layers. Each absorber layer exhibits a sheet resistance of at least 10⁵ Ohms/sq. Further, the article exhibits a deadfront color shift (ΔE) of less than 4.0 for incident, measuring angles from 0° to 90°, as measured relative to a control article comprising the glass, glass-ceramic or ceramic material of the substrate and a standard black matrix disposed on the glass, glass-ceramic or ceramic material.

Embodiment 2. The cover article of Embodiment 1 is provided, wherein the cover article exhibits an average, two-surface transmittance from 40% to 80% in the visible spectrum from 400 nm to 700 nm.

Embodiment 3. The cover article of Embodiment 1 or Embodiment 2 is provided, wherein the cover article exhibits an average, first-surface photopic reflectance of less than 4%.

Embodiment 4. The cover article of any one of Embodiments 1-3 is provided, wherein each of the high refractive index layers in the outer layered film comprises Si₃N₄, SiNₓ, SiOₓN_{y}, AlNₓ, AlOₓN_{y}, SiAlₓO_{y}N_{z}, TiO₂, HfO₂, ZrO₂, Nb₂O₅ or Ta₂O₅, and wherein each of the low refractive index layers in the outer layered film comprises a silicon-containing oxide.

Embodiment 5. The cover article of any one of Embodiments 1-4 is provided, wherein the inner layered film comprises the one or more absorber layers.

Embodiment 6. The cover article of any one of Embodiments 1-5 is provided, wherein each absorber layer exhibits an average absorptance of 1% to 60% in the visible spectrum from 400 nm to 700 nm.

Embodiment 7. A cover article for a display panel is provided that includes: a substrate comprising a thickness from 50 μm to 5000 μm, an outer primary surface and an inner primary surface, wherein the outer and inner primary surfaces are opposite of one another and the substrate comprises a glass, glass-ceramic or ceramic material; an inner layered film disposed on the outer primary surface of the substrate; and an outer layered film disposed on the inner layered film. The inner layered film comprises a plurality of low refractive index and absorber layers. The outer layered film comprises a plurality of alternating high refractive index and low refractive index layers. Each of the high refractive index layers has a refractive index greater than a refractive index of each of the low refractive index layers. In addition, each absorber layer comprises a metal or a metal alloy. Each absorber layer exhibits a sheet resistance of at least 10⁵ Ohms/sq and an extinction coefficient of greater than 0.5 in the visible spectrum from 400 nm to 700 nm.

Embodiment 8. The cover article of Embodiment 7 is provided, wherein each absorber layer comprises Ni, Cr, a Ni-containing alloy, a Cr-containing alloy, or a Ni/Cr alloy.

Embodiment 9. The cover article of Embodiment 8 is provided, wherein each absorber layer comprises Cr and has a thickness of less than 2 nm.

Embodiment 10. The cover article of Embodiment 8 is provided, wherein each absorber layer comprises Ni and has a thickness of less than 1 nm.

Embodiment 11. The cover article of any one of Embodiments 7-10 is provided, wherein the inner layered film comprises two (2) to twenty (20) absorber layers.

Embodiment 12. The cover article of any one of Embodiments 7-11 is provided, wherein each of the high refractive index layers in the outer layered film comprises Si₃N₄, SiNₓ, SiOₓN_{y}, AlNₓ, AlOₓN_{y}, SiAlₓO_{y}N_{z}, TiO₂, HfO₂, ZrO₂, Nb₂O₅ or Ta₂O₅, and wherein each of the low refractive index layers in the outer layered film and the inner layered film comprises a silicon-containing oxide.

Embodiment 13. The cover article of any one of Embodiments 7-12 is provided, wherein the cover article exhibits an average, two-surface transmittance from 40% to 80% in the visible spectrum from 400 nm to 700 nm, and an average, first-surface photopic reflectance of less than 4%.

Embodiment 14. A cover article for a display panel is provided that includes: a substrate comprising a thickness from 50 μm to 5000 μm, an outer primary surface and an inner primary surface, wherein the outer and inner primary surfaces are opposite of one another and the substrate comprises a glass, glass-ceramic or ceramic material; an inner layered film disposed on the outer primary surface of the substrate; and an outer layered film disposed on the inner layered film. One or both of the inner layered film and the outer layered film comprises one or absorber layers. The outer layered film comprises a plurality of alternating high refractive index and low refractive index layers. Each of the high refractive index layers has a refractive index greater than a refractive index of each of the low refractive index layers. In addition, each absorber layer comprises a diamond-like carbon (DLC) material. Each absorber layer exhibits a sheet resistance of at least 10⁵ Ohms/sq and an extinction coefficient of from about 0.05 to about 0.4 in the visible spectrum from 400 nm to 700 nm.

Embodiment 15. The cover article of Embodiment 14 is provided, wherein each absorber layer comprises a thickness from about 5 nm to about 500 nm.

Embodiment 16. The cover article of Embodiment 14 or Embodiment 15 is provided, wherein the one or both of the inner layered film and the outer layered film comprises one (1) to ten (10) absorber layers.

Embodiment 17. The cover article of any one of Embodiments 14-16 is provided, wherein a total thickness of the absorber layers is from 25 nm to 500 nm.

Embodiment 18. The cover article of any one of Embodiments 14-17 is provided, wherein each of the high refractive index layers in the outer layered film comprises Si₃N₄, SiNₓ, SiOₓN_{y}, AlNₓ, AlOₓN_{y}, SiAlₓO_{y}N_{z}, TiO₂, HfO₂, ZrO₂, Nb₂O₅ or Ta₂O₅, and wherein each of the low refractive index layers in the outer layered film and the inner layered film comprises a silicon-containing oxide.

Embodiment 19. The cover article of any one of Embodiments 14-18 is provided, wherein the cover article exhibits an average, two-surface transmittance from 40% to 80% in the visible spectrum from 400 nm to 700 nm, and an average, first-surface photopic reflectance of less than 4%.

Embodiment 20. The cover article of any one of Embodiments 14-19 is provided, wherein the article exhibits a deadfront color shift (ΔE) of less than 4.0 for incident, measuring angles from 0° to 90°, as measured relative to a control article comprising the glass, glass-ceramic or ceramic material of the substrate and a standard black matrix disposed on the glass, glass-ceramic or ceramic material.

Embodiment 21. A cover article for a display panel includes: a substrate comprising a thickness from 50 μm to 5000 μm, an outer primary surface and an inner primary surface, wherein the outer and inner primary surfaces are opposite of one another and the substrate comprises a glass, glass-ceramic or ceramic material; an inner layered film disposed on the outer primary surface of the substrate; and an outer layered film disposed on the inner layered film. The inner layered film comprises a plurality of low refractive index and one or more absorber layers, the outer layered film comprises a plurality of alternating high refractive index and low refractive index layers, each of the high refractive index layers has a refractive index greater than a refractive index of each of the low refractive index layers, and each absorber layer is a silicon-metal alloy comprising Si—Al, Si—Sn, Si—Zn or a combination thereof. Further, each absorber layer exhibits a sheet resistance of at least 10⁵ Ohms/sq and an extinction coefficient of greater than 1.0 in the visible spectrum from 400 nm to 700 nm.

Embodiment 22. The cover article of Embodiment 21 is provided, wherein the silicon-metal alloy does not contain any silicides.

Embodiment 23. The cover article of Embodiment 21 or Embodiment 22 is provided, wherein each absorber layer has a thickness of less than 100 nm.

Embodiment 24. The cover article of any one of Embodiments 21-23 is provided, wherein the silicon-metal alloy is Si—Al with at least 69% silicon (by volume).

Embodiment 25. The cover article of any one of Embodiments 21-23 is provided, wherein the silicon-metal alloy is Si—Sn with at least 60% silicon (by volume). Embodiment 26. The cover article of any one of Embodiments 21-23, wherein the silicon-metal alloy is Si—Zn with at least 80% silicon (by volume).

What is claimed is:

1. A cover article for a display panel, comprising:
a substrate comprising a thickness from 50 μm to 5000 μm, an outer primary surface and an inner primary surface, wherein the outer and inner primary surfaces are opposite of one another and the substrate comprises a glass, glass-ceramic or ceramic material;
an inner layered film disposed on the outer primary surface of the substrate; and
an outer layered film disposed on the inner layered film; and
wherein one or both of the inner layered film and the outer layered film comprises one or more absorber layers,
wherein the outer layered film comprises a plurality of alternating high refractive index and low refractive index layers,
wherein each of the high refractive index layers has a refractive index greater than a refractive index of each of the low refractive index layers, and
wherein each absorber layer exhibits a sheet resistance of at least 10⁵ Ohms/sq, and
further wherein the article exhibits a deadfront color shift (ΔE) of less than 4.0 for incident, measuring angles from 0° to 90°, as measured relative to a control article comprising the glass, glass-ceramic or ceramic material of the substrate and a standard black matrix disposed on the glass, glass-ceramic or ceramic material.

2. The cover article of claim 1, wherein the cover article exhibits an average, two-surface transmittance from 40% to 80% in the visible spectrum from 400 nm to 700 nm.

3. The cover article of claim 1, wherein the cover article exhibits an average, first-surface photopic reflectance of less than 4%.

4. The cover article of claim 1, wherein each of the high refractive index layers in the outer layered film comprises Si₃N₄, SiNₓ, SiOₓN_{y}, AlNₓ, AlOₓN_{y}, SiAlₓO_{y}N_{z}, TiO₂, HfO₂, ZrO₂, Nb₂O₅ or Ta₂O₅, and wherein each of the low refractive index layers in the outer layered film comprises a silicon-containing oxide.

5. The cover article of claim 1, wherein the inner layered film comprises the one or more absorber layers.

6. The cover article of claim 1, wherein each absorber layer exhibits an average absorptance of 1% to 60% in the visible spectrum from 400 nm to 700 nm.

7. A cover article for a display panel, comprising:
a substrate comprising a thickness from 50 μm to 5000 μm, an outer primary surface and an inner primary surface, wherein the outer and inner primary surfaces are opposite of one another and the substrate comprises a glass, glass-ceramic or ceramic material;
an inner layered film disposed on the outer primary surface of the substrate; and
an outer layered film disposed on the inner layered film; and
wherein the inner layered film comprises a plurality of low refractive index and absorber layers,
wherein the outer layered film comprises a plurality of alternating high refractive index and low refractive index layers,
wherein each of the high refractive index layers has a refractive index greater than a refractive index of each of the low refractive index layers,
wherein each absorber layer comprises a metal or a metal alloy, and
further wherein each absorber layer exhibits a sheet resistance of at least 10⁵ Ohms/sq and an extinction coefficient of greater than 0.5 in the visible spectrum from 400 nm to 700 nm.

8. The cover article of claim 7, wherein each absorber layer comprises Ni, Cr, a Ni-containing alloy, a Cr-containing alloy, or a Ni/Cr alloy.

9. The cover article of claim 8, wherein each absorber layer comprises Cr and has a thickness of less than 2 nm.

10. The cover article of claim 8, wherein each absorber layer comprises Ni and has a thickness of less than 1 nm.

11. The cover article of claim 7, wherein the inner layered film comprises two (2) to twenty (20) absorber layers.

12. The cover article of claim 7, wherein each of the high refractive index layers in the outer layered film comprises Si₃N₄, SiNₓ, SiOₓN_{y}, AlNₓ, AlOₓN_{y}, SiAlₓO_{y}N_{z}, TiO₂, HfO₂, ZrO₂, Nb₂O₅ or Ta₂O₅, and wherein each of the low refractive index layers in the outer layered film and the inner layered film comprises a silicon-containing oxide.

13. The cover article of claim 7, wherein the cover article exhibits an average, two-surface transmittance from 40% to 80% in the visible spectrum from 400 nm to 700 nm, and an average, first-surface photopic reflectance of less than 4%.

14. A cover article for a display panel, comprising:
a substrate comprising a thickness from 50 μm to 5000 μm, an outer primary surface and an inner primary surface, wherein the outer and inner primary surfaces are opposite of one another and the substrate comprises a glass, glass-ceramic or ceramic material;
an inner layered film disposed on the outer primary surface of the substrate; and
an outer layered film disposed on the inner layered film; and
wherein one or both of the inner layered film and the outer layered film comprises one or more absorber layers,
wherein the outer layered film comprises a plurality of alternating high refractive index and low refractive index layers,
wherein each of the high refractive index layers has a refractive index greater than a refractive index of each of the low refractive index layers,
wherein each absorber layer comprises a diamond-like carbon (DLC) material or a silicon-metal alloy comprising Si—Al, Si—Sn, Si—Zn or a combination thereof,
further wherein, when each absorber layer comprises the DLC material, each absorber layer exhibits a sheet resistance of at least 10⁵ Ohms/sq and an extinction coefficient from about 0.05 to about 0.4 in the visible spectrum from 400 nm to 700 nm, and
wherein, when each absorber layer is the silicon-metal alloy, each absorber layer exhibits a sheet resistance of at least 10⁵ Ohms/sq and an extinction coefficient of greater than 1.0 in the visible spectrum from 400 nm to 700 nm.

15. The cover article of claim 14, wherein each absorber layer comprises a thickness from about 5 nm to about 500 nm.

16. The cover article of claim 14, wherein the one or both of the inner layered film and the outer layered film comprises one (1) to ten (10) absorber layers.

17. The cover article of claim 14, wherein a total thickness of the absorber layers is from 25 nm to 500 nm.

18. The cover article of claim 14, wherein each of the high refractive index layers in the outer layered film comprises Si₃N₄, SiNₓ, SiOₓN_{y}, AlNₓ, AlOₓN_{y}, SiAlₓO_{y}N_{z}, TiO₂, HfO₂, ZrO₂, Nb₂O₅ or Ta₂O₅, and wherein each of the low refractive index layers in the outer layered film and the inner layered film comprises a silicon-containing oxide.

19. The cover article of claim 14, wherein the cover article exhibits an average, two-surface transmittance from 40% to 80% in the visible spectrum from 400 nm to 700 nm, and an average, first-surface photopic reflectance of less than 4%.

20. The cover article of claim 14, wherein the article exhibits a deadfront color shift (ΔE) of less than 4.0 for incident, measuring angles from 0° to 90°, as measured relative to a control article comprising the glass, glass-ceramic or ceramic material of the substrate and a standard black matrix disposed on the glass, glass-ceramic or ceramic material.

21. (canceled)

22. (canceled)

23. (canceled)

24. (canceled)

25. (canceled)

26. (canceled)
